(19) United States
(12) Patent Application Publication
(10) Pub. No.: US 2004/0000519 A1
(43) Pub. Date: Jan. 1, 2004

(54) Field-flow fractionation method and apparatus

(75) Inventors: Yong Jiang, Florence, SC (US); Michael E. Miller, Spokane, WA (US); Marcus N. Myers, Salt Lake City, UT (US); Andreas M. Kummerow, Terre Haute, IN (US); Soheyl Tadjiki, Salt Lake City, UT (US); Marcia E. Hansen, Salt Lake City, UT (US); Thorsten Klein, Diessen (DE)

Correspondence Address: POSTNOVA ANALYTICS, INC., 4797 SOUTH WESTRDIGE BLVD, SALT LAKE CITY, UT, 84118, US

(73) Assignee: Postnova Analytics, Inc.

(21) Appl. No.: 10/184,764

(22) Filed: Jun. 28, 2002

(51) Int. Cl. B01D 11/00

(52) U.S. Cl. 210/634; 210/635; 210/656; 210/748; 436/161; 436/180

(57) ABSTRACT

An improved field-flow fractionation method and apparatus for the separation of sample species 28 contained in a carrier fluid, wherein

a stream of the sample species-containing carrier fluid is forced through a flow channel 14 having a depletion wall 18, an accumulation wall 20, side walls, a channel inlet 10, and a channel outlet 34, by introducing the sample species-containing carrier fluid into the flow channel 14 through the channel inlet 10 and withdrawing the sample species-containing carrier fluid through the channel outlet 34,

a field 32 is applied to the carrier fluid in the flow channel 14 to induce a driving force on the sample species 28 acting across the flow channel 14 from the depletion wall 18 towards the accumulation wall 20 and perpendicular to the orientation of the main axis of the flow channel 14,

the sample species 28 are subjected to fractionation as they flow through the flow channel 14 and emerge as sample species fractions at the channel outlet 34, wherein

at least one additional stream of sample species-depleted carrier fluid is introduced into the flow channel 14 through at least one orifice 12 and the relative flow rates of the different streams are adjusted such that the stream of sample species-containing carrier fluid is positioned adjacent to the accumulation wall 20 and the sample species-depleted carrier fluid is positioned between the depletion wall 18 and the sample species-containing carrier fluid,

no mechanical barrier being provided inside the flow channel 14 between the orifice 12 and the channel inlet 10 for separating the stream of sample species-depleted carrier fluid introduced through the orifice 12 and the stream of sample species-containing carrier fluid introduced through the channel inlet 10.

### 1. THE FIELD OF THE INVENTION

This invention relates generally to analytical separation techniques such as field-flow fractionation. More specifically, the present invention relates to a method and a device for splitting and/or combining two or more sample and liquid flows into or out of an analytical separation apparatuses, and in particular into or out of a field-flow fractionation separation system or channel.

### 2. PRESENT STATE OF THE ART

2.1 Description of Field-Flow Fractionation, FFF

Field-flow fractionation is a separation and characterization technique that relies on the effects of an applied field on a sample that is carried by a fluid flow. This fluid flow moves down the length of a channel that will hereinafter be referred to by the term “channel flow”.

The character and strength of the interaction between the species in the sample and the field plays a decisive role in the separation. Species that more weakly interact with the field are more rapidly carried away by the fluid flow that moves perpendicular to the applied field. This leads to different retention times for different species in the sample. Field-flow fractionation was disclosed in U.S. Pat. No. 3,449,938, and it is an excellent technique to separate and characterize a great variety of species. (Field-flow fractionation is also known as single phase chromatography, polarization chromatography, and capillary hydrodynamic fractionation.) These species include cells, sub-cellular particles, viruses, liposomes, protein aggregates, fly ash, colloids, industrial lattices and pigments, polymers, humic materials, proteins and nucleic acid molecules such as DNA. Some of these species are dissolved in the fluid flow that carries the sample, whereas other species are better characterized as being suspended in the fluid flow. Consequently, the terms “sample fluid” and “sample” will hereinafter refer to the fluid that contains the sample species, regardless of the form in which such species are contained in the fluid medium (i.e., whether dissolved, dispersed, suspended or in any other form of aggregation in the fluid flow). Furthermore, terms such as “sample species”, “particles” or “particle”, and “component” or “components”, will hereinafter characterize the entity or entities in the sample to be analyzed, or more particularly, in the sample that contains the entities to be separated. More particularly, these terms used in the specific context of field-flow fractionation refer to any sample species that can be retained and separated by any field-flow fractionation, including rigid and deformable particles ranging in size from submicron to hundreds of microns, polymer molecules, aggregates and clusters, biological macromolecules, and particles including cells, DNA, proteins and any other molecules that are capable of analysis by field-flow fractionation.

The great variety of sample species that can be separated and characterized by field-flow fractionation makes this technique an important tool for solving problems in plurality of fundamental and applied research areas that include biology, medicine, material, and environmental sciences. More specifically, field-flow fractionation has been applied to sample species whose masses span a 10¹⁵-fold range. These species encompass molecules with a mass of about 600 Daltons and increasingly bigger entities up to particles of about 100 micrometers in diameter.

The choice of the applied field in field-flow fractionation depends on the particular property that controls the retention time of the sample species that is to be separated. The types of applied fields that can be used in implementing field-flow fractionation include thermal, gravitational, electric, magnetic and other gradients. In addition, a cross flow with respect to the carrier is used in flow field-flow fractionation, a very versatile and effective implementation of the field-flow fractionation principles. Other types of applied fields that have in fact been applied and that are of potential practical relevance as a driving force in field-flow fractionation include forces due to dielectrical, concentration gradient, acoustic, photophoretic, and shear effects. A short-hand notation that consists of the acronym FFF preceeded by the name of the applied field is used hereinafter. Available commercial types of field-flow fractionation are flow FFF, thermal FFF, and sedimentation FFF. These types differ by the type of applied field. In flow FFF, the field that drives separation is a flow stream directed perpendicular to the channel flow longitudinal axis. A method and apparatus for flow FFF is described in U.S. Pat. No. 4,147,621. In thermal FFF, a thermal gradient is used as the field to drive separation. Acceleration is used to drive separation is sedimentation FFF. In particular, this acceleration is that of a centrifugal field in sedimentation FFF, and it is the gravitational field in gravitational FFF. Unless otherwise specified, the terms “field” or “applied field” will hereinafter refer to any applied field, to a cross flow and to any appropriately generated potential gradient that creates a driving force that directs the sample species towards a wall of the channel called the accumulation wall. Furthermore, the examples and illustrations offered herein refer in particular to flow FFF because this field-flow fractionation technique is currently established as a very versatile and effective technique. In addition, flow FFF has been characterized as the most universal of the field-flow fractionation methods. J. Calvin Giddings, “Field-Flow Fractionation”, Chemical and Engineering News, Vol. 66 (1988), pp. 34-35; Particle Size Distribution II, ACS Symposium Series No. 472, S. Kim Ratanathanawongs, Inho Lee, and J. Calvin Giddings, “Separation and Characterization of 0.01-50 μm Particles Using Flow Field-Flow Fractionation”, 191, Chapter15, pp. 229-46.

2.1.a. Operating Modes of FFF

For each applied field there are in turn a variety of operating modes. Each operating mode depends on the sample species separation mechanism. For example, sample species under the influence of an applied field may be subject to a diffusive, steric, or hydrodynamic lift effects. Depending on which one of these effects is predominant, the field-flow fractionation operating mode is, respectively, a Brownian, steric, or hyperlayer mode. Consequently, each appropriate choice of applied field and operating mode leads to a different field-flow fractionation sub-technique.

Whereas sample species separation according to mass or size is often the goal of field-flow fractionation, this is not the only possible application of field-flow fractionation. With the appropriate choice of applied field, a field-flow fractionation apparatus can perform as a micro-balance sensitive to forces of 10⁻¹⁶ N. Furthermore, field-flow fractionation permits the measurement of both particle size and density, from which a molar mass can be calculated. Other properties that can be calculated include particle diameter and charge. The high sensitivity of sedimentation FFF to very small amounts of adsorbed material permits the measurement of the mass and thickness of adsorbed layers. When the sample species population is heterogeneous in any of these properties, the different components are separated by field-flow fractionation on the basis of the heterogeneous property and a distribution curve relative to this property is obtained. These and other background materials pertaining to field-flow fractionation have been described by J. Calvin Giddings, “Measuring Colloidal and Macromolecular Properties by FFF”, Analytical Chemistry, Volume 59, (1995) pages 592A-598A.

2.1.b. FFF Operating Principles.

In a field-flow fractionation apparatus the carrier flows under laminar regime conditions along a narrow channel and a field is applied orthogonally to the carrier flow, hereinafter referred to as channel flow. One of the characteristics of laminar flow is that the flow velocity is parabolic. Accordingly, the carrier moves slower near the walls and increasingly faster in regions closer to the center line of the channel along the longitudinal axis. As applied, the field drives sample species towards the accumulation wall. Concentration-based or Brownian diffusional processes drive the sample species away from the accumulation wall. For smaller species, the diffusional processes are more rapid. As a result of the combination of field-driven migration and diffusional processes, the sample species equilibrate in zones of different shapes, dependent on the magnitude of field-sample interaction and the sample diffusion coefficient. (Typically, the channel is positioned so that the bottom channel wall is the accumulation wall and the top channel wall is the depletion wall. Hereinafter, the terms “bottom channel wall” and “top channel wall” will refer to the accumulation and depletion walls, respectively.) For example, a species with reduced field interaction and with larger diffusional rates forms a zone that is more expanded and that extends from the accumulation wall further towards the center line of the channel. The expanse of the zones for different sample species varies, so that the laminar flow through the channel transports each sample species with different momenta depending on the channel flow region to which they are driven. The sample species are initially and ideally concentrated in a very small plug or sample pulse near the channel inlet. In the course of flow displacement, particles that weakly interact with the field will move more quickly through the channel than the particles that strongly interact with the field. Therefore, rapidly swept particles are part of an outflow fraction that leaves the field-flow fractionation apparatus sooner than the fractions that contain the particles that more strongly interact with the field. More succinctly, the retention time of a particle depends on the interaction between the relevant property of the particle and the applied field.

2.1.c. FFF Separation Efficiency.

Field-flow fractionation techniques are often classified with chromatographic techniques since both set of techniques physically separate sample species and provide information based on the elution or retention time of each sample species. Elution data is recorded using a sample sensitive detection system which is in fluid contact with the channel flow from the channel outlet. A graph of detector response versus time plots a peak for each sample species. A goal shared by FFF and chromatographic techniques is the separation of peaks. The separation efficiency in separating peaks can be quantified using plate height measurements. Plate height is equivalent to the channel (or column length) by the square of the ratio of the standard deviation of the peak height to the peak elution time. The term “band broadening” refers to effects which decrease separation efficiency and which increase the standard deviation of the peak. (See Modern Size Exclusion Chromatography, W. W. Yau, J. J. Kirkland, and D. D. Bly, John Wiley & Sons, Inc., (1979) pp. 53-96.) It is desirable, therefore, that the plate height parameter be minimal in magnitude. There are several factors which contribute to plate height. These include the experimental conditions, e.g. channel flow rate, field strength, channel dimensions and structure and sample characteristics. For FFF, many of the plate height factors are well-characterized and can be expressed mathematically.

2.2 Sample Introduction Methods

In the initial operation of the FFF and other analytical separation techniques, a plug of sample, also referred to as a sample pulse, is injected into the channel flow at or near the channel inlet. Typically, a small volume of sample is injected to avoid dispersion or band broadening of the sample plug. Band broadening is detrimental as it reduces the resolution of separation. In current practice, the volume of the sample plug is limited by band broadening effects. The injected volume is typically 1-20 micro-liters or less than 10% of the total volume of the FFF channel.

Field-flow fractionation is dissimilar to other analytical separation techniques because it utilizes an applied field for separation. Because of this feature, an additional sample introduction step is required for optimal resolution of separation. This process is the relaxation of the sample species with respect to the applied field. Equilibration is equivalently used in this context for relaxation. When the sample pulse is first introduced into the FFF channel, it is generally distributed broadly over the channel cross section. Before the sample migration step is implemented, the sample species are subjected to a relaxation process in which they approach a steady state distribution within the channel, usually by accumulating near one channel wall. The steady state distribution normally corresponds to a balance of the sample-field interaction which drives sample components towards the accumulation wall and Brownian diffusion which drives sample away from the accumulation wall.

There are several methods for introducing sample into the field-flow fractionation channel. When referring to a sample, the terms “introducing”, “injecting”, or derivatives thereof are used as equivalent terms that encompass any procedure for incorporating into a channel a sample that is to be separated or for introducing a flow into a conduit. Some methods provide a relaxed sample distribution. Other techniques merely position the sample components next to a wall without providing equilibration of the sample components with the field.

2.2.a. The stop-flow method is the most commonly used method and it provides a fully relaxed distribution. This method involves turning off the channel flow immediately following the sample injection and allowing the applied field to act upon the sample. This process both positions the sample at the wall and allows the sample components to equilibrate. The disadvantage of this method is that the channel flow must be turned on and off; this typically requires an additional switching valve and extra time for equilibration. Furthermore, turning the flow on and off generates a pressure transient. The pressure transient generation is a most detrimental effect because the detectors used with FFF systems are sensitive to pressure transients. As a consequence of the pressure transient, the detector signal is distorted from its normal baseline value and a significant amount of time may be required for the detector to return to baseline. Whenever the detector response is disturbed, the separation cannot be accurately monitored, especially for species that elute at the beginning of the separation stage. Additionally, the pressure transient may broaden or otherwise disturb the sample zone which is precisely positioned in its equilibrium distribution during the previous stop-flow period. Either of these reasons will cause poor separation resolution. In addition to these undesired pressure pulses, a stop-flow process may also lead to another undesirable effect, which is adhesion of sample species at the accumulation wall.

A desirable feature of this method, however, is that the sample does not travel down the channel as it relaxes on the accumulation wall. Travel down the channel tends to increase band broadening effects and broadening of the initial sample. Terms such as “dispersion”, “broadening”, “spreading” or equivalents thereof, will be used herein for describing the extension of volume occupied by the sample whose components are to be separated. The stop-flow method is described in Particle Size Distribution II, ACS Symposium Series No. 472, S. Kim Ratanathanawongs, Inho Lee, and J. Calvin Giddings, Separation and Characterization of 0.01-50 μm Particles Using Flow Field-Flow Fractionation, 1991, Chapt.15, pp. 229-46.

2.2.b. Pinched inlet method. Some alternate methods have been suggested for positioning the sample near the accumulation wall. U.S. Pat. No. 5,141,651 describes a pinched channel inlet system. In this method, the thickness of the channel is reduced in the area of injection. Specifically, the structure of the channel is modified so that the position of the top or depletion channel wall is lowered. Consequently, the injected sample is, from the start, positioned closer to the accumulation wall. A pinched inlet channel system, however, has some shortcomings. First, since the flow through the channel is not discontinued in this method, the sample travels down the channel while also being relaxed towards the accumulation wall. This leads to increased band broadening effects and a broadened initial sample plug. Second, engineering the pinched inlet presents severe difficulties because high performance FFF channels are already very thin, typically 100-200 micrometers. Because of this small dimension, reducing the channel thickness near the inlet is very difficult and can hardly be done with sufficient precision. Third, the reduced channel thickness in the pinched inlet must be even if the same linear flow velocity in all areas of the pinched inlet is to be maintained. Manufacturing a channel with an even channel thickness of just a few micrometers in the pinched inlet area is difficult. This dimension is determined by the typical thickness of an equilibrated sample zone, which is of the order of 1-10 micrometers. Fourth, at high channel flow rates, eddy currents may be generated at the interface between the pinched inlet area and the full channel thickness. Such eddy currents are undesirable because they may disturb the distribution of sample next to the accumulation wall. Finally, the reduced thickness of the channel at the inlet is susceptible to clogging.

2.2.c. Hydrodynamic relaxation procedures. Another process and apparatus for positioning sample near the accumulation wall are described in U.S. Pat. No. 5,193,688, and by Min-Kuang Liu, Stephen Williams, Marcus N. Myers, and J. Calvin Giddings, Hydrodynamic Relaxation in Flow Field-Flow Fractionation Using both Split and Frit Inlets, Analytical Chemistry, Vol. 63 (1991), pp. 2115-22. This process is known as hydrodynamic sample relaxation and it involves a permeable wall element, hereinafter referred to as a “frit”, positioned close to the sample inlet. This element is used to provide a separate flow stream that hydrodynamically forces sample to the accumulation wall. The frit is placed in the top channel wall, known as the depletion wall and the flow from this element is distributed over the frit area immediately above the small inlet section of the channel where hydrodynamic relaxation is to be achieved. Flow is directed into this element using a separate pump and/or a flow control valve “tee-ed” into the carrier pump flow line. The amount of flow can be externally controlled to adjust the amount of viscous force that is applied to push the sample next to the accumulation wall. Thus, this relaxation process may be manipulated externally. The frit inlet device is convenient for flow FFF techniques since the depletion wall is generally permeable to begin with.

In comparison to the pinched inlet, the channel structure required for hydrodynamic sample relaxation is easier to implement. Nevertheless, this method has some disadvantages. For use of a frit element for hydrodynamic relaxation, other disadvantages stem from the nature of frits. For example, frits shed particles which contaminate the fractions produced by FFF. Also, the particles which are gradually shed from frits interfere with the signal of light scattering detectors and elemental detectors which are commonly used in conjunction with FFF and other analytical separations. Another disadvantage of the use of frits is the non-uniform flow through the pores and open spaces contained within the frit. Since a distribution of pore sizes is found in frits, the linear velocity of flow through the frit is varied. Additionally, the distribution of pore sizes makes it difficult to calculate the resistance to flow imposed by a frit. Also frits are subject to clogging and cannot be visually inspected to determine whether a clog is present. Mechanical difficulties are presented with the use of a frit element for hydrodynamic relaxation. For laminar flow conditions, the depletion channel wall should be flat, smooth and parallel to accumulation wall. Thus, mechanical requirements are put on the insertion of the frit element. Limits on the chemical composition of carrier solutions are imposed on the frit inlet FFF channel: Since the edges of the frit must be sealed within the top channel block, the chemical compatibility of the seal agent (epoxy, silicone, rubber, etc.) with the carrier must be considered. Many organic solvents which are good solvents for polymeric sample species may be detrimental to the seal agent used in the frit inlet FFF channel construction. Additionally, the frit itself may not be compatible with higher pH conditions as ceramics degrade at pHs above 10.

2.2.d. Split Inlet Hydrodynamic Relaxation. Hydrodynamic relaxation can also be accomplished using a split inlet, as well as the frit inlet or pinched systems. The principles of hydrodynamic relaxation, whether by split inlet or frit inlet, are the same. The split inlet involves the addition of a channel inlet into the bottom or accumulation channel wall and a thin barrier between the top and bottom channel inlets. This barrier, termed the “splitter” extends a short distance down the channel. The function of the splitter is to briefly isolate the top channel inlet flow from the bottom channel inlet flow. The splitter extends a short distance down the channel and the two channel inlet flow streams collide shortly after the end of the channel splitter. Typically, sample is introduced through the bottom channel inlet at a relatively slow flow rate. Sample-less flow at a high flow rate is introduced from the top channel inlet. Collision of the top flow stream with the bottom sample flow stream serves to drive the sample species towards the bottom channel wall.

For use of a splitter to accomplish hydrodynamic relaxation, several mechanical difficulties are inherent. Firstly, the splitter must be very thin with respect to the channel thickness, so as to avoid introduction of flow turbulence. Since the channel thickness is itself thin, in the range of 100-200 μm, the ideal splitter thickness should be of micron to sub-micron dimensions which is difficult for current routine machining capabilities. Also these devices are very fragile and not very resistant to mechanical forces. Secondly, the splitter must be smooth, flat and positioned parallel to the channel walls. For proper operation, the splitter must be suspended evenly across the several centimeter wide gap of the thin channel; unevenness amounting to a few tens of micrometers will noticeably distort the hydrodynamic relaxation process. Again, the thin dimensions of the channel, make these mechanical requirements difficult. Additionally, the splitter materials should be compatible with buffered fluid carriers or biological samples which are often used in FFF operation. For some FFF systems, the type of field employed further exacerbates the mechanical strength requirements of the splitter. For example, application of a centrifugal field may cause on otherwise flat splitter to bow or bend.

Use of the splitter typically requires the use of a channel inlet in the bottom channel wall. Placement of this inlet in the bottom channel wall is often problematic. For example, the bottom channel wall of the flow FFF channel consists of a membrane supported by a ceramic frit. The membrane is typically an ultra-filtration type of membrane which is constructed polymer film(s) and which is subject to fouling so that frequent replacement is required for operation of the Flow FFF channel. Difficult construction procedures are necessary to seal the channel outlet and to position it with an opening flush with the surface of the replaceable membrane.

The expected similarity in the results of the split and frit inlet systems has been confirmed by Min Kuang Liu, Stephen Williams, Marcus N. Meyers, and J. Calvin Giddings, Hydrodynamic Relaxation in Flow Field-Flow Fractionation Using Both Split and Frit Inlets, Analytical Chemistry, Vol. 63 (1991) pp. 2115 et seq. The advantages shared by pinched inlet and hydrodynamic relaxation are the use of continuous channel flow. Since the channel flow is not stopped, no pressure transient is generated and the detector does not have to be re-stabilized following the pressure transient. Another advantage of continuous channel flow is that the sample is also continuously moving tangential to the surface of the accumulation wall. For this reason, there is less opportunity for adsorption of sample onto the accumulation wall. The major disadvantage of any sample introduction method involving continuous sample and carrier flow is the width or volume of the resulting sample plug. A compressed sample plug is desirable as it improves the resolution of the separation.

2.2.e. Opposed Flow Focusing Methods. U.S. Pat. Nos. 6,109,119 and 6,192,764 B1 describe a recently developed sample introduction method, which addresses the harmful effects of a large initial sample plug. Publications by K. G. Wahlund and J. C. Giddings, Properties of an Asymmetric Flow Field-Flow Fractionation Channel Having One Permeable Wall, Analytical Chemistry, Vol. 59 (1987), pp 1332-39, S. K. R. Williams and J. C. Giddings, Particle Size Analysis of Dilute Environmental Colloids by Flow Field-Flow Fractionation Using an Opposed Flow Sample Concentration Technique, Analytical Chemistry, Vol. 70 (1998), pp. 2495-2503, and H. L. Lee, J. F. G. Reis, J. Dohner, and E. N. Lightfoot, AlChE Journal, Vol. 20 (1974), pp. 776-84 describe a similar method, termed “outlet flow sample focusing”, for use in the rectangular channels of Asymmetrical Flow FFF and of Symmetrical Flow FFF and in tubular channels, respectively. Each method leads to a focused sample plug by the use of two opposing flows directed down the length of the channel. Whether tubular or rectangular cross section channels are used, the channels employed by this method are constructed with one or more walls that are permeable to carrier flow. In the Symmetrical Flow FFF channel, both accumulation and depletion channel walls are permeable to flow; the Asymmetric Flow FFF channel is so termed as only one channel wall is permeable to carrier flow. The tubular channel consists of a hollow, solvent-permeable, fiber.

The use of two opposing flows generates a focused sample in the following manner: Sample is introduced at or near the channel inlet, but between the sources of the two opposing flows. One source of the opposing flow is located at or near the beginning of the channel. The second flow stream is located further down the channel. The patented methods differ from the outlet flow sample focusing method in the location of introduction point of an opposing flow stream. An innovative feature of the patented methods is to introduce the down channel flow stream at a mid-point position of the channel instead of through the channel outlet. An interface is formed between the two opposing flows; the position of the interface is governed by the relative flow rates of the opposing flow streams. Typically, the flow rates are controlled so that the interface is positioned after the sample introduction point, near the channel inlet. Due to the action of the opposing flows sample species are dragged and the sample plug is focused into a narrow band located at this interface.

Following the sample separation step, the separated sample species are carried out of the channel to a detection system. After the detection system, the separated sample species may be individually collected for analysis by other analytical techniques. Typically the detection system is in fluid communication with the channel by means of tubing. The channel flow carries the sample through the channel outlet through the connecting tubing to the detector cell. Hereinafter, the flow stream which carries sample species from the channel outlet to the detector shall be termed the “detector flow stream”.

An advantage imparted by these sample focusing techniques is that a large volume of sample can be introduced without causing a broad sample plug. For outlet flow sample focusing, detrimental effects are generated after the sample introduction method is completed: Sample separation follows the sample introduction method. Between sample introduction and sample separation, the flow directed from the channel outlet is discontinued. During the sample separation technique all carrier flow is directed down the channel and through the detector. Thus flow must be stopped and reversed in the transition from sample introduction to sample separation. The result of this is a pressure transient in the channel. The detrimental effects of the pressure transient are that the relaxed sample zones and the detector signal are disturbed. These unfavorable effects can be avoided in the patented methods by using an additional flow inlet located at a mid-point of a channel wall. An opposing flow stream is introduced through this inlet during sample introduction. Between sample introduction and sample separation, the flow through this inlet is diverted to an inlet placed at the beginning of the channel. Alternatively, the flow through the mid-point inlet can be ramped down to zero flow at the same rate that the flow through an inlet placed at the beginning of the channel is ramped up. The purpose of either method is to maintain the same total amount of flow through the channel outlet. The desired result is that the flow through the detector and through the latter portion of the channel is kept constant so that a minimal pressure transient is generated.

The major disadvantage of the focusing methods is the extra accessory equipment, software and firmware, which are necessary for controlling the focusing process. An extra pump is typically necessary to drive the opposing flow stream. To switch off or ramp the opposing flow stream, (as is necessary prior to the sample separation step), a valve and/or software plus firmware control is needed.

Another major disadvantage of the focusing method is the increased intolerance to non-uniformities of the channel dimensions. The breadth and thickness dimensions at each cross-sectional slice of the channel determine the linear velocity of fluid at that point. The linear velocities of the channel and opposing flows determine the position and shape of the interface plane where these two flow streams meet. For effective sample focusing, the channel flow and its opposing flow must meet at the focusing point with flow profiles that are perpendicular to top, bottom and side channel walls. Otherwise, the sample is not focused into a plane that is appropriately positioned for the separation step that follows.

2.3. Liquid Removal Methods

While sample introduction has a strong impact on the separation performance, the manner in which sample species are removed from the channel also has a significant effect on the separation efficiency. Band broadening effects result if the connecting tubing is relatively long. This is due to laminar type of flow through the tubing. With laminar flow, the band of sample species removed from the channel will start as a relatively small plug of sample, but spread and flow through the tubing as a bullet-shaped band. The length of the bullet that flows through the detector cell is directly related to the length of tubing and indirectly related to the linear velocity of the flow through the tubing. For these reasons, the typical sample removal technique in field-flow fractionation employs short lengths of narrow bore tubing. If possible, the use of slower flow rates for transfer of sample from the channel to the detector will also decrease the band broadening effects.

2.3.a. Stream Splitting methods. The use of stream splitting to improve the sample removal process has been suggested using several different means, e.g. using a flat planar splitter, a permeable wall element or frit, or a stream splitter based on the use of concentric tubes. (See Outlet Stream Splitting for Sample Concentration in Field-Flow Fractionation, J. C. Giddings, H. C. Lin, K. D. Caldwell, and M. N. Myers, Separation Science Technology, 18, 293-306 (1983), Hydrodynamic Relaxation and Sample Concentration in Field-Flow Fractionation Using Permeable Wall Elements, J. C. Giddings, Analytical Chemistry, 62, 2306-2312 (1990), and Improved Flow Field-Flow Fractionation System Applied to Water-Soluble Polymers: Programming, Outlet Stream Splitting, and Flow Optimization, K. -G. Wahlund, H. S. Winegarner, K. D. Caldwell, and J. C. Giddings, Analytical Chemistry, 58, 573-578 (1986), respectively.) The benefit offered by stream splitting is enhanced concentration of separated sample species made possible by the isolation of sample species to positions in close proximity to the accumulation wall. That is, if the bottom laminae of channel flow which contains mostly sample is split from the upper laminae of channel flow which does not contain sample, then the detector flow stream will be more concentrated. Each stream splitting device inherently requires an additional channel outlet. One outlet continues the typical channel outlet function of connecting the channel flow to the detector cell. The other outlet now releases sample-free channel flow. For optimal performance, the split of flow should not result in any substantial hydrodynamic mixing of two flow streams.

2.3.b. The split outlet device, hereinafter referred to as the “split outlet”, is similar in form to the split inlet which was described earlier. It uses the same principle of two split flows but at two different locations of the channel and yielding different advantages. With this device, a flat, planar element is used as a barrier between the two channel outlets to both split and isolate the two flow streams. The additional channel outlet is placed in the bottom channel wall. The barrier, or “splitter”, extends a short distance down the length of the channel from the channel outlet towards the channel inlet. With use of the splitter, the two flow streams split from the channel flow are physically isolated so as to avoid hydrodynamic mixing and to further avoid disturbing the bands of separated sample species. Other requirements for best performance are that the splitter should be thin relative to the channel thickness and flat across the channel breadth with smooth surfaces.

2.3.c. Concentric Tube Stream Splitter. Another means of splitting the channel flow involves the replacement of the channel outlet with two concentric tubes mounted such that the inner tube protrudes beyond the opening of the outer tube. We term this stream splitting device as the “concentric tube stream splitter”. Basically, this stream splitting device is constructed by inserting a tube inside of the conventional channel outlet. The inlet to the inner tube is positioned in close proximity to the channel accumulation wall. The entrance to the outer tube is flush with the upper wall of the channel. With this orientation, the detector flow stream will be collected by the inner tube and will consist of the laminae of channel flow located near the accumulation wall and containing most of the sample. The requirements of this construction are in precise placement of the inner tube, alignment of the inner tube for concentricity with the outer tube and some means of sealing the concentric tube assembly.

2.3.d. Frit Outlet method. Also the so-called frit outlet was suggested as an improved means of splitting the channel flow streams and is described in U.S. Pat. No. 5,193,688. The frit outlet device involves the use of a permeable wall element placed near the channel outlet. Typically, the frit is located in the top channel wall and adjacent to the conventional channel outlet. The preferred embodiment employs a ceramic frit of similar breadth as the channel breadth. The mechanical requirements of the frit outlet device are that the frit must be placed with its bottom surface flush with the top channel wall. Also, the frit should be equally permeable across its surface and its bottom surface must be flat and smooth.

2.3.e. Disadvantages of current stream splitters. While each of the aforementioned stream splitting devices provides the benefit of increased sample concentration in the detector flow stream, none of these devices lack disadvantages. With the split outlet, there are the same machining difficulties for the splitter and for the additional channel outlet, as well as the chemical compatibility limits introduced by using the splitter element in the channel where contact with sample and carrier solutions, as mentioned earlier for the split inlet. Placement of the concentric tubing stream splitter near the accumulation wall involves positioning with a precision of 10-50 microns as typical channel thicknesses range from 100-200 microns. Moreover, the inner tube must be centered across the breadth of the channel. The sealing mechanism of the concentric tubing must ideally be accomplished without increasing the length of the tubing connecting to the detector cell so as to avoid excessive band broadening effects.

The frit outlet device is possibly the easiest stream splitter to machine. However, as discussed previously for the frit inlet, frits are subject to clogging and visual inspection cannot determine whether the frit is clogged. Extraordinary means must also be taken to determine whether the pore size distribution is homogeneous so that there is even flow through the permeable wall element. The hydrodynamic properties of a frit are difficult to calculate so that the resistance to flow induced by slot must be measured empirically. The frit must be sealed into the top channel wall and the use of common sealing materials will limit the range of organic solvents that can be used as carrier fluids.

### 3. OBJECTS OF THE INVENTION

It is desirable to simplify the general construction of the FFF separation channel. A channel design which minimizes the use of foreign elements such as splitters or frits is desirable so that a wide range of carrier solutions and samples are chemically compatible with the channel materials in contact with carrier fluids and samples. It is advantageous to limit the presence of foreign elements due to possibility of contaminants being introduced by these elements. A simplified channel construction provides the additional benefit of minimized production costs and time and more total product precision.

It is further desirable to avoid the use of frit elements as these may be clogged by sample species and the pore sizes found within a frit are variable so that the flow of liquid through the frit is not homogeneous.

It is desirable to simplify the operation procedure of the separation system. It is further an object to minimize the amount of accessory equipment, software, and firmware needed for operation of the separation instrument and to minimize the analysis time without reducing the resolution of the separation.

It is desirable to simplify the sample injection and positioning step by avoiding any stop flow procedures during the separation to facilitate and/or enable the use of various detection systems.

It is desirable to decrease the channel outlet flow, which contains the sample and transfers it to the detectors, to minimize band broadening effects, and to simplify coupling to modern detection systems as mass spectroscopy.

An additional object is to maximize the concentration of the separated sample species in the detector flow stream. This allows for increased sensitivity of the analysis technique to lower levels of sample species and to detect samples which can not be detected otherwise. Additionally, the fractions collected after detection can be better characterized by other analytical techniques if sample concentration is maximized.

It is desirable to cover a huge application range with FFF including fragile polymers, aggregates and particles. In the past some of these samples could not be analyzed successfully using the current focusing, injection and relaxation methods.

It is desirable to avoid damage to and adsorption of fragile samples, such as huge polymers, aggregates and vesicles, on the FFF membrane by using an improved injection and relaxation step.

It is desirable to speed up FFF separations and to minimize analysis time by an improved injection and relaxation step.

It is a further object to provide an improved FFF process which can be adapted to any of the above-noted FFF techniques. Still further objects will become apparent from a consideration of the ensuing description and drawings.

### 4. BRIEF SUMMARY OF THE INVENTION

It has now been found that these and other objects can be accomplished with a modified but simple channel design using a new so called “Flow Splitting Process” for the sample and the carrier flow. This new method of flow splitting can be used at both ends of the FFF separation channel or only at one of the channel ends. It can be used at the inlet end of the channel for the so called “liquid introduction split” and it can be used at the channel outlet end for the so called “liquid removal split”. An additional advantage is that it can be utilized for all FFF sub-techniques, which means it is not restricted to only one FFF technique. Using these flow splitting method at the beginning and the end of the FFF separation channel helps to overcome the problems discussed before which are associated with the sample injection, the hydrodynamic sample relaxation, the use of different sensitive and pressure dependent detectors and also with sample concentration problems (detection limit).

The flow channel (FFF channel) for use in the method and apparatus of the invention comprises a depletion wall (“top”), an accumulation wall (“bottom”), side walls, a channel inlet for introducing sample species-containing carrier fluid and a channel outlet for withdrawing sample species-containing carrier fluid. A stream of carrier fluid is forced through the flow channel from the channel inlet to the channel outlet along the depletion and accumulation walls. The channel inlet is located upstream to the channel outlet. Similarly, the terms “inlet end” and “outlet end” as used herein refer to positions in the flow channel where the inlet end is upstream relative to the outlet end. The dimensions of the flow channel are not specifically limited and are usually as conventional in this art. Specifically, it is desirable that the ratio of the height (distance between depletion and accumulation walls) to width (distance between sidewall along the flow direction through the channel) is chosen so as to allowing a laminar flow throughout the channel. The length of the flow channel (distance from the inlet end wall to the outlet end wall) is not limited, either. As is generally known in this art, the length will influence the separation power of the flow channel.

The liquid introduction split at the channel inlet end for sample injection and positioning is used in the following way: the sample pulse is introduced the channel inlet into a stream of carrier fluid that enters the inlet of the FFF channel as the sample species-containing carrier fluid. A second sub-stream of sample species-deplete carrier fluid is introduced such that the sample species-containing carrier fluid is positioned adjacent to the accumulation wall and the sample species-depleted carrier fluid is positioned between the stream of sample species-containing carrier fluid and the depletion wall. The term sample species-depleted carrier fluid as used herein means carrier fluid that has a lower concentration of sample species than the sample species-containing carrier fluid. Preferably, the sample species-depleted carrier fluid is free of sample species.

The sample species-depleted carrier fluid may be introduced downstream with respect to the channel inlet through which the sample species-containing fluid is introduced into the flow channel. The flow of sample species-depleted carrier fluid generates a viscous force which drags sample species towards the channel accumulation wall and enables a continuous and smooth positioning and equilibration.

The positioning step is achieved by inserting an orifice, e.g., in the depletion wall of the field-flow fractionation channel near the channel inlet in the downstream direction. This hole is in fluid communication with the FFF channel and with a pump or any other apparatus that functions to drive fluid into the channel. The term orifice as used herein refers to an opening or bore within a wall (accumulation wall, depletion wall or side wall) of the flow channel for introducing or withdrawing fluid and having no further inserts, in particular having no frit insert. In one embodiment of the invention, the orifice is produced by drilling a hole in a wall of the flow channel, e.g. by means of a laser. The liquid introduction orifice is preferably in the form of a slot, preferably aligned with its long axis perpendicular to the long axis of the flow channel, i.e. perpendicular to the direction of flow through the channel. Its size is preferably chosen so as to avoid eddy currents when introducing the sample species-depleted carrier fluid. Accordingly, the length of the diameter along the short axis is preferably limited, whereas the length of the long axis is not specifically limited, but preferably not longer than the width of the flow channel itself.

Prior art channel designs for hydrodynamic relaxation required the use of frit elements or mechanical barriers such as splitter elements. It is thus surprising that the design requires fewer elements than previous channel designs for hydrodynamic relaxation. Specifically, it is strongly desirable to provide a laminar flow of the different streams inside the flow channel immediately after introduction through the inlet or orifice, thus preventing the mixing of sample species-containing carrier fluid and sample species-depleted carrier fluid. Contrary to the conventional teaching in this art, it was found that such laminar flow can be obtained even without specific barriers such as frits or splitters.

The liquid removal split at the channel outlet end uses the same principle as the liquid introduction split process at the channel inlet end, except that the direction of the flows is different. At the channel inlet end two flows are combined using the split method, whereas at the channel outlet end two flows are separated using the split technique.

The stream splitting process of the liquid removal split therefore typically, but not only, occurs at the downstream end of the channel. The sample species are carried down the length of the channel after the positioning/equilibration step in which sample species are positioned near the bottom channel wall. Separation of the sample species according to the principles of FFF occurs during the transit down the channel. When the separated sample species reach downstream positions close to the channel outlet, the channel flow stream is split into two flow streams; the flow stream comprising the upper laminae of channel flow is released, e.g., through the upper channel wall (depletion wall). The flow stream comprising the bottom laminae of channel flow exits the channel through the channel outlet. As the bottom laminae in an operating FFF channel contain most of the sample species, the carrier flow exiting the channel outlet has an increased sample concentration relative to the concentration that would occur without this type of stream splitting.

The stream splitting process is accomplished by placing a hole (orifice), e.g., in the depletion wall of the FFF channel in a position upstream of and near the channel outlet. The upper laminae of flow are directed out of the channel through this hole. Preferably, this orifice for withdrawing fluid is of circular shape. The bottom laminae of flow continue further down the channel to exit out of the channel through the channel outlet. The channel outlet is in fluid communication with a detector system which determines the amount or concentration of sample species in the flow stream. The detector system is often in fluid communication with a fraction collector so that the separated sample species can be collected for further analyses. Other channel designs for stream splitting required the use of frit elements or splitter elements. It is thus surprising that the design requires only an orifice in a channel wall. Fewer elements than previous channel designs for hydrodynamic relaxation are required. In particular, it was unexpectedly found that mechanical devices such as splitters and frit outlets are not required in order to maintain a laminar flow at the outlet end of the flow channel.

### 5. BRIEF DESCRIPTION OF THE DRAWINGS

FIG. 1A: Three dimensional rendering of a preferred embodiment of the liquid introduction device.

FIGS. 1B, 1C: Three dimensional schematics of other embodiments.

FIG. 2: Implementation of the liquid introduction device for positioning of the sample.

FIG. 3A: Length-wise, cross-sectional view of a preferred embodiment of the liquid introduction device.

FIG. 3B: Transverse cross-sectional view at the implementation point of the preferred embodiment.

FIG. 3C: Schematic top view of channel with one embodiment of the liquid introduction device.

FIG. 4: Schematic drawing showing the sample enrichment effect achieved by using a liquid removal device.

FIG. 5A: Length-wise, cross-sectional view of a preferred embodiment of the liquid removal device.

FIG. 5B: Transverse cross-sectional view at the implementation point of the preferred embodiment of a liquid removal device.

FIG. 5C: Schematic top view of the channel with one embodiment of the liquid removal device.

FIGS. 6A-E: Length-wise, cross sectional views of additional embodiments of the liquid introduction device.

FIG. 6F: Top view of an additional embodiment of the liquid introduction device.

FIGS. 7A-E: Length-wise cross sectional views of additional embodiments of the liquid removal device.

FIG. 7F: Top view of an additional embodiment of the liquid introduction device.

FIG. 8: Expanded view showing the construction of a preferred embodiment of the liquid introduction and a liquid removal device.

FIGS. 9A-C: Elution profiles found with the liquid introduction method of the present invention (FIG. 9A) and with prior art methods (FIGS. 9B and 9C)

FIG. 10: The fractograms resulting from the use of a prior art frit outlet device.

FIG. 11A: Fractogram results obtainable with a liquid removal device of the present invention.

ELEMENT NUMBERING

channel inlet 10

liquid introduction orifice 12

channel 14

terminal inlet end 16

depletion wall 18

accumulation wall 20

orifice flow stream 22

channel inlet flow stream 24

inlet splitting plane 26

Sample material 28

steady-state position 30

applied field 32

channel outlet 34

terminal outlet end 36

liquid introduction port 38

liquid introduction channel 40

liquid introduction device, 42

inlet side wall 44

outlet side wall 46

liquid removal orifice 50

outlet splitting plane 52

sample material 54

channel outlet flowstream 56

liquid removal channel 58

liquid removal port 60

liquid removal device 62

channel spacer 64

device spacer 66

device block 68

frit 70

block 72

top clamping block 74

bottom clamping block 76

### 6. DESCRIPTION OF THE DEVICE

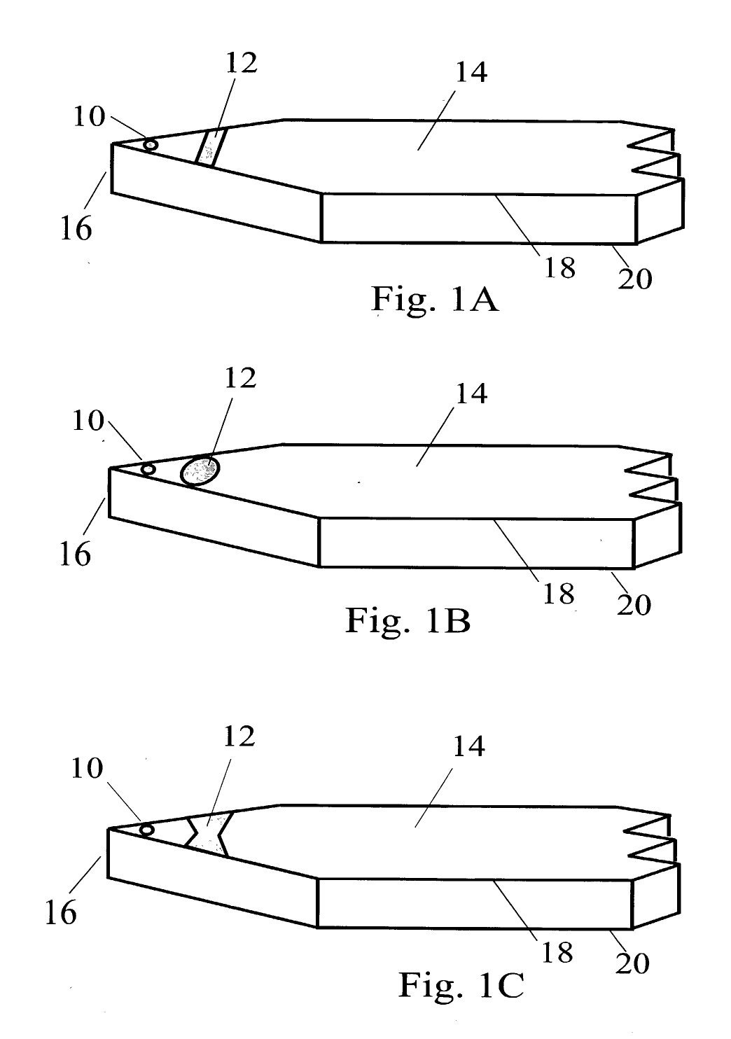

6.1 Description of a Liquid Introduction Device—FIGS. 1, 3 and 6

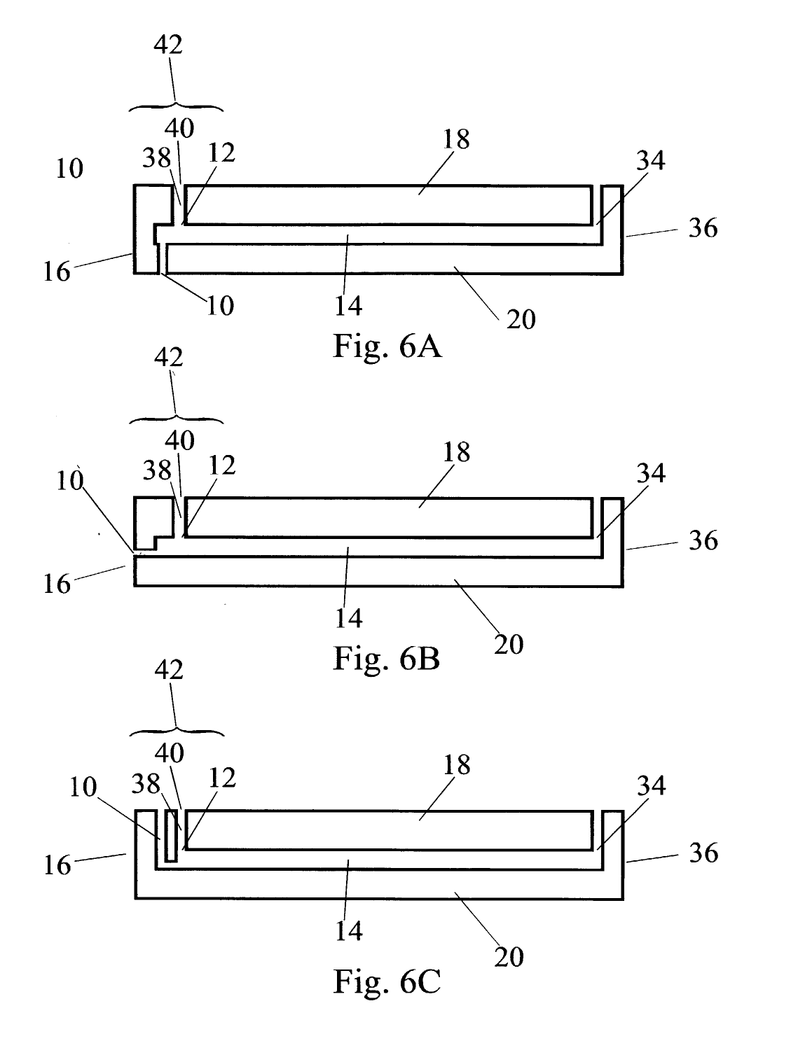

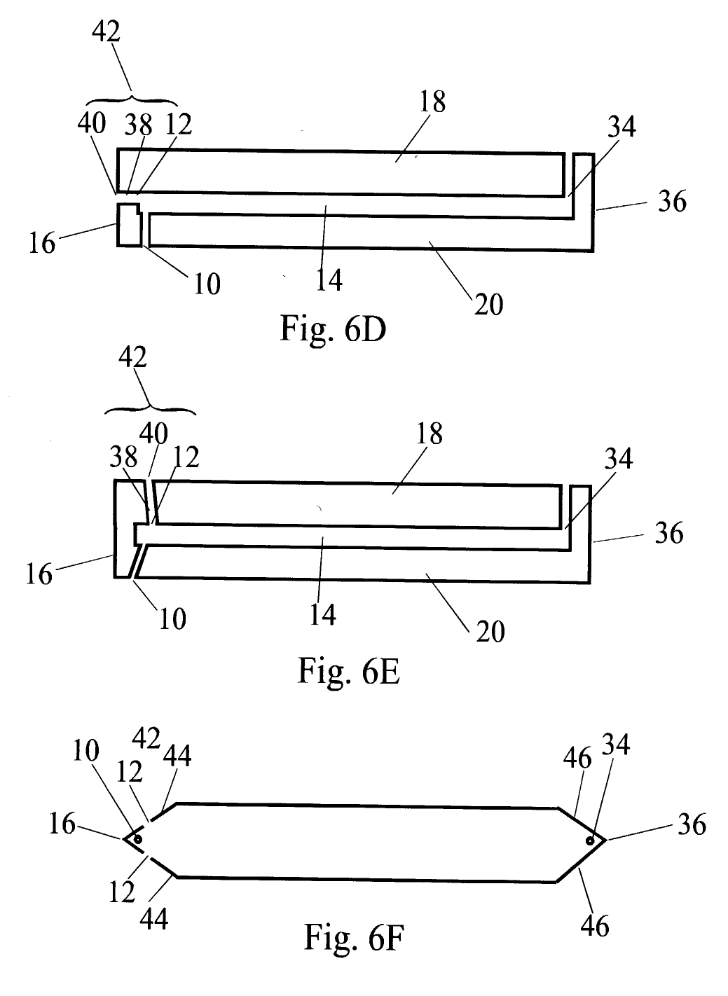

Shown in FIG. 1A is a schematic drawing showing a channel inlet 10 and an orifice 12 in channel 14. Channel inlet 10 is located near the closed terminal inlet end 16. Channel 14 is closed on top and bottom by the depletion channel wall 18 and accumulation wall 20, respectively. With reference to FIG. 1B, this figure shows another possible location and shape of a liquid introduction orifice 12. With reference to FIG. 1C, this figure shows another possible location and shape of orifice 12. Many other shapes are possible for the orifice. In the exemplary embodiments herein described and in other embodiments of the liquid introduction device and method, the position of channel inlet 10 can be shifted to locations other than that indicated in FIGS. 1A-C. For example, channel inlet 10 can be placed in depletion channel wall 18 or accumulation channel wall 20. In the same manner, the orifice can be shifted to locations other than that indicated in FIGS. 1A-C including, without limitation, depletion wall 18, accumulation wall 20, or side channel walls (labeled only in FIG. 6F). The liquid introduction orifice can be implemented in the form of one or two orifices, or a system of multiple orifices and the locations of these orifices can be in different channel walls. Illustration of a few other implementations is shown in FIG. 6F.

The shape of channel 14 shown in FIG. 1A is merely exemplary. For example, channel 14 may also be tapered so that the breadth is larger at one end of the channel, as will be appreciated by those familiar with field-flow fractionation. Furthermore, a tubular channel or a channel with rectangular or differently shaped cross section could be used, and the breadth or thickness of the channel, i.e. its cross section, need not be constant over the length of the channel, but may be varying or uniform. For example, a pinched inlet channel has a reduced channel breadth near the channel inlet. A cross-sectional view of this example is shown in FIG. 6C.

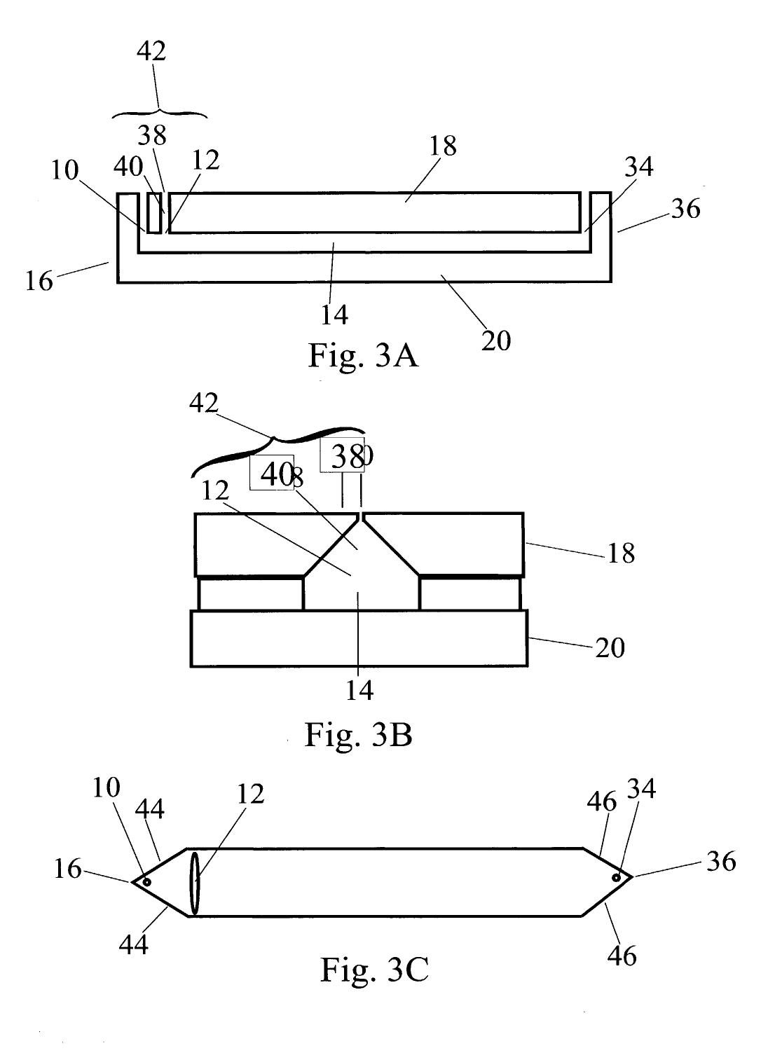

With reference to FIGS. 3A, 3B, and 3C, cross-sectional views of one embodiment of a liquid introduction device is shown. Presented in FIG. 3A is a length-wise, cross-sectional view of the channel with the liquid introduction device. The channel inlet 10 and liquid introduction orifice 12 are located in the depletion wall 18 near the terminal inlet end 16 of channel 14. A channel outlet 34 is located at or near the closed terminal outlet end 36 of the channel 14 in channel depletion wall 18. In other embodiments the channel inlet 10 and/or channel outlet 34 may be located in the accumulation wall 20 and/or in the closed terminal inlet and outlet ends, 16 and 36, respectively. Sample material is transported by carrier liquid that enters into channel 14 through channel inlet 10. Carrier liquid is also fed through the liquid introduction port 38, through a liquid introduction channel 40, and finally through a liquid introduction orifice 12 into channel 14. A liquid introduction device 42 consists of port 38, channel 40, and orifice 12.

Presented in FIG. 3B is a transverse, cross-sectional view at the position of the preferred embodiment of a liquid introduction orifice 12 and of channel 14 with a liquid introduction device 42. The breadth of device 42 is tapered with the smallest breadth at port 38 and the largest breadth at orifice 12 opening into channel 14. In the preferred embodiment, the largest breadth of device 42 is the same breadth as channel 14. Carrier liquid enters channel 14 through the liquid introduction port 38 which is in fluid contact with a pump (not shown), on through channel 40, and finally through orifice 12.

FIG. 3C shows a top view of channel 14 with an embodiment of the liquid introduction device. Elements 44 and 46 are inlet and outlet side walls, respectively.

In FIGS. 3A-C, liquid introduction device 42 is located between the channel inlet 10 and the channel outlet 36. Preferably, device 42 is generally located in the first third of the length of channel 14. In a more preferred embodiment of this invention, liquid introduction device 42 includes a slot shaped orifice 12 with a breadth similar to the breadth of channel 14, a channel 40 which serves as a feed chamber to deliver carrier fluid to orifice 12, and a liquid introduction port 38 which connects the liquid introduction device to a fluid delivery device, such as a pump (not shown).

FIGS. 6A-F show other possible locations of a channel outlet 10 and liquid introduction orifice 12. FIG. 6A is a schematic showing implementation of a channel outlet 10 in depletion wall 20. The possibility of locating a channel inlet in terminal inlet end 16 is depicted in FIG. 6B. FIG. 6C illustrates the combination of a liquid introduction orifice 12 in combination with a pinched inlet which uses a reduced channel thickness between a terminal inlet end 16 and an orifice 12. FIG. 6D shows the possibility of locating a liquid introduction device in terminal inlet end 16. FIG. 6D also depicts the use of a channel inlet located in depletion wall 20. The option of using a channel inlet 10 that enters at an angle to channel 14 is shown in FIG. 6E. Also shown in FIG. 6E. is a channel 40 which connects a port 38 to an orifice 12 at an angle not perpendicular to channel 14. FIG. 6F is a schematic of a top view of a channel with more than one orifice 12 and location of orifices 12 in inlet side walls 44.

Many options remain which are not depicted by a figure. For example, an embodiment may be contemplated wherein the channel inlet is located in the lower portion of the terminal end of the channel and the orifice is located in the upper portion of the terminal end of the channel. Furthermore, an option not shown but possible is the use of a channel 40 in which the walls of channel 40 are not parallel to each other. Another possibility is the implementation of the liquid introduction device with a channel 40 in which the cross sectional channel shape is selected from a group of shapes that include circular, triangular, trapezoidal, and many other shapes. The size of channel 40 can vary and so lead to yet other embodiments.

6.2 Benefits of the Liquid Introduction Device

The liquid introduction device eliminates the complications found with previous sample introduction, relaxation, and equilibration devices. In comparison to the channel design used for stop-flow relaxation, the liquid introduction device no longer requires a valve and valve control devices (software and firmware). Versus hydrodynamic relaxation devices, a simple orifice is required only and the use of foreign elements such as frits or splitters are avoided.

The use of frits or splitters to achieve hydrodynamic relaxation is disadvantageous as these elements may contaminate the channel flow stream with foreign elements which are erroneously interpreted by the detector system as sample species. Often the materials used as the frit or splitter are not compatible with the pH, salt or organic solvent content of the carrier. Additionally, some sample species interact with the materials used to construct the frit or splitter. In these cases, a compromise in the experimental conditions must be made. This reduces the performance of the sample analysis and may even prevent the analysis of certain samples.

The physical structure of frits is inherently disadvantageous. Frits have many narrow gaps through which carrier flows. These gaps are subject to clogging and removal of these clogs is difficult if not impossible. The flow characteristics of the frit may change if the frit is clogged and result in detrimental changes of the hydrodynamic relaxation characteristics. If the frit becomes extremely clogged, pressure can build up so that the fluid delivery system fails or bursts. The use of splitters creates similar difficulties. Since the channel is already thin, insertion of a splitter creates a narrow gap above and below the splitter.

The use of an orifice avoids these difficulties as the orifice dimensions are typically larger than the gaps found in frits and in channels with a splitter. In the rare case that the orifice gets clogged, cleaning is a simple procedure. The dimensions of the orifice can be well-defined so that the hydrodynamics of flow can be predicted, whereas the hydrodynamics of a frit cannot be determined unless extra-ordinary efforts are taken to reduce contaminants in the carrier and to characterize the distribution of pore sizes.

Significant commercial advantages are provided by the simplified channel design found in the liquid introduction device of the present invention. Machining an orifice into a channel wall is a less stringent process than the manufacture of a splitter or implementation of a frit element. The splitter must be thin relative to a channel only 100's of micron thick, flat as positioned across a cm wide gap, and smooth. The frit element must be placed in the channel wall with its bottom surface co-planar with the channel wall. A seal must be made around the frit to hold the frit in place and prevent leaks around the edges of the frit.

Splitters and frits are required by previous hydrodynamic relaxation devices. The most recent relaxation device which involves opposed flow focusing requires precise control of the channel cross sections as defined by channel breadth and thickness. Otherwise the focus plane is not correctly positioned in the channel. These machining requirements, e.g. flat and smooth surfaces, thin and rigid elements, precise element positioning and/or precise channel dimensions, are eliminated with the liquid introduction device design of the present invention.

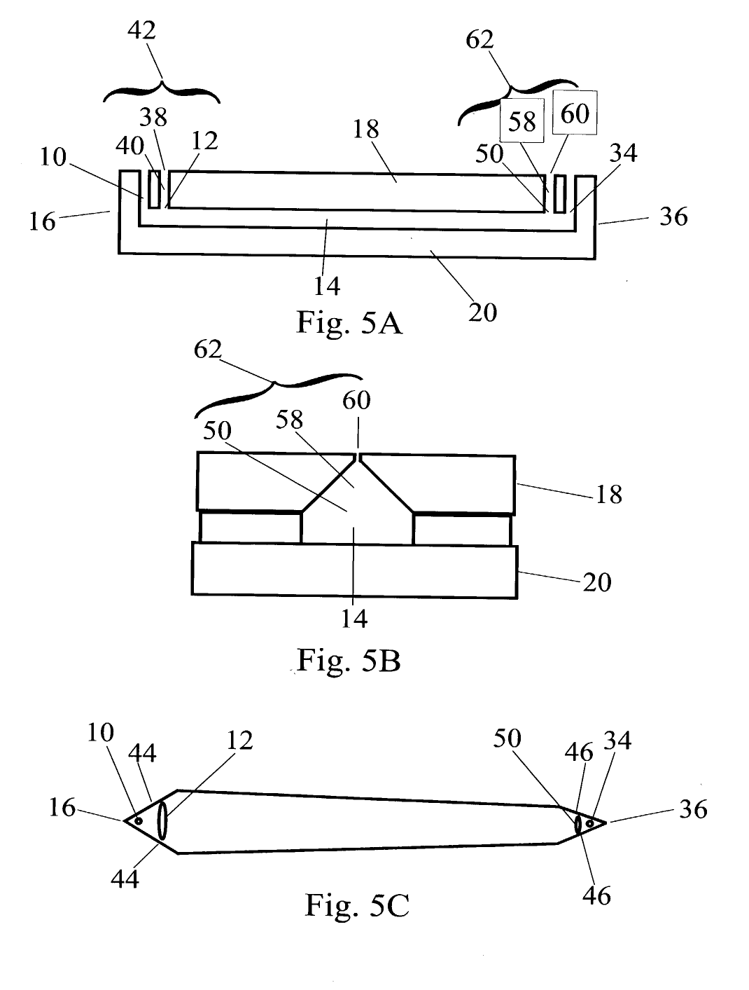

6.3 Description of the Liquid Removal Device—FIGS. 5, 7 and 8

FIGS. 5A-C display different views of the basic elements of a preferred embodiment of the liquid removal device with channel outlet 34 and liquid removal orifice 50 located in channel 14, near the terminal outlet end 36. With reference to FIGS. 5A and 5B, cross-sectional views of one embodiment of the liquid removal device and channel 14 are shown. Presented in FIG. 5A is a length-wise, cross-sectional view of the channel with the liquid removal device. Channel outlet 34 is located at or near a closed terminal outlet end 36 of channel 14 in channel depletion wall 18. Sample material is transported by carrier liquid that exits channel 14 through channel outlet 34. Carrier liquid is removed through the liquid removal orifice 50, through liquid removal channel 58, and finally through liquid removal port 60. A liquid removal device 62 consists of the liquid removal orifice 50, a liquid removal channel 58, and a liquid removal port 60.

Presented in FIG. 5B is a transverse, cross-sectional view at the position of the preferred embodiment of a liquid removal device 62 and of channel 14. The breadth of device 62 is tapered with the smallest breadth at the liquid removal port 60 and the largest breadth at liquid removal orifice 50. In one embodiment, the largest breadth of liquid introduction device 62 is the same breadth as channel 14. Carrier liquid exits channel 14 through the liquid removal orifice 50, on through channel 58, and finally through port 60. Carrier liquid containing sample exits channel 14 through the channel outlet 34.

FIG. 5c shows the top view of a channel with one embodiment of the liquid introduction device and liquid removal device.

In the exemplary embodiments herein described and in other embodiments of the liquid removal device and method, the position of channel outlet 34 can be shifted to locations other than that indicated in FIG. 5A. For example, channel outlet 34 can be placed in the depletion channel wall 18 or the accumulation channel wall 20. In the same manner, the liquid removal orifice 50 can be shifted to locations other than that indicated in FIGS. 5A-C including, without limitation, the top channel wall, the bottom channel wall, the side channel walls. The liquid removal orifice can be implemented in the form of one or two orifices, or a system of multiple orifices and the locations of these orifices can be in different channel walls.

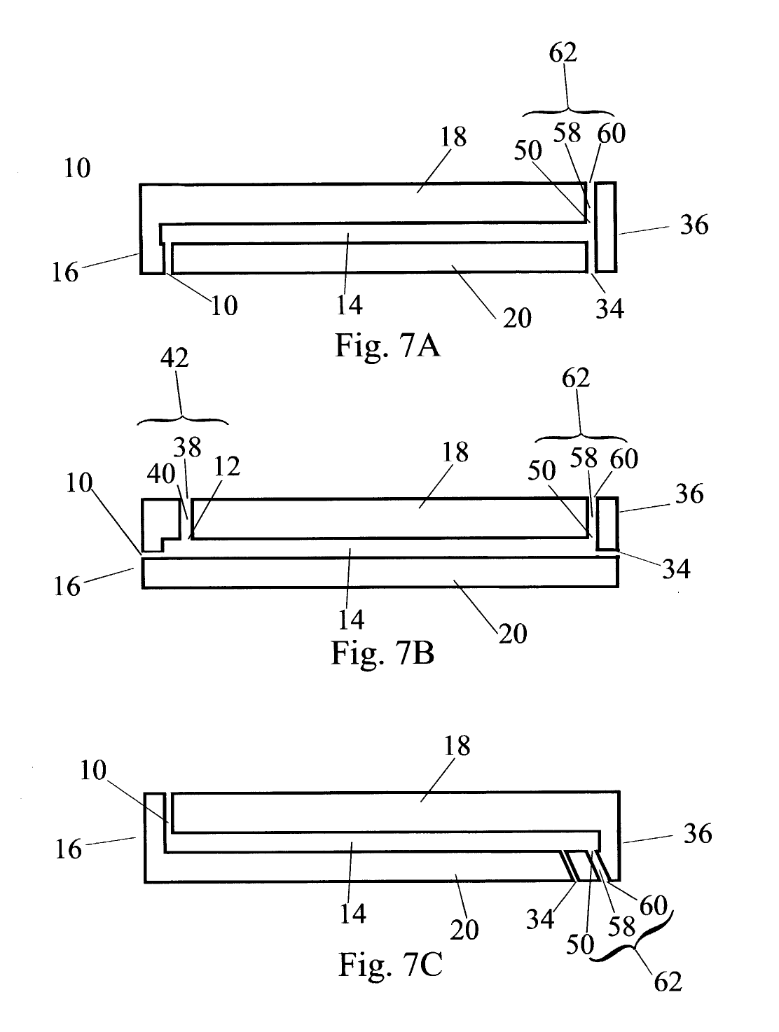

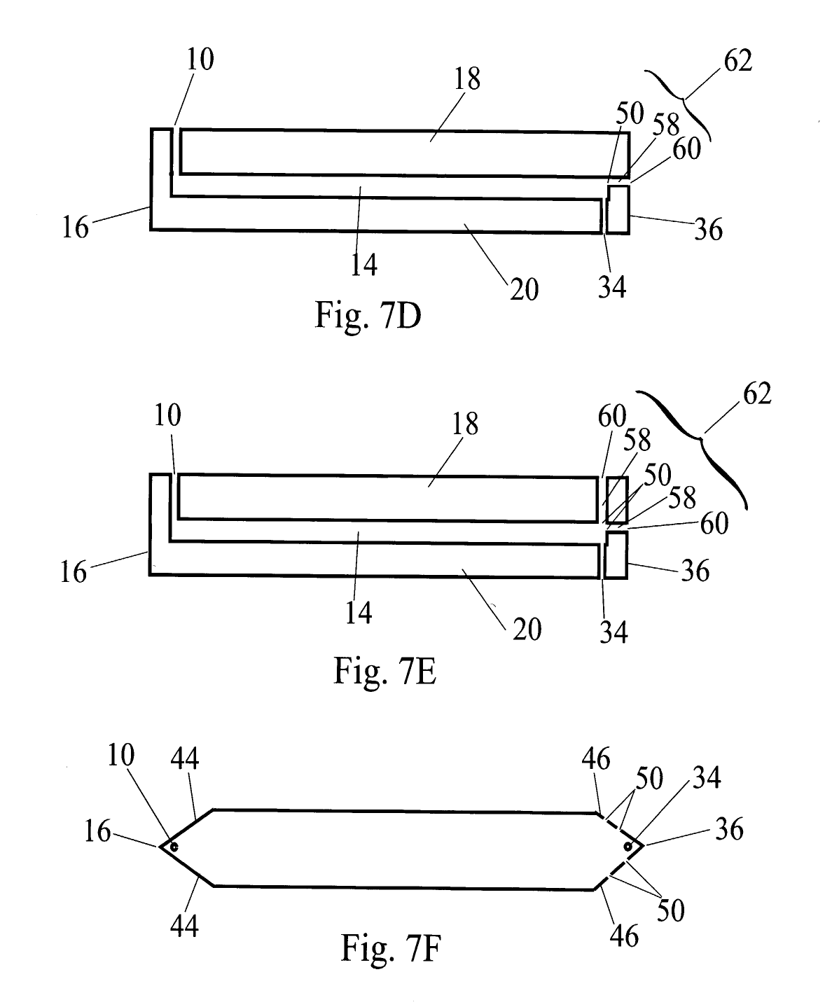

FIGS. 7A-F show other possible locations of a channel outlet 34 and a liquid removal orifice 50. FIG. 7A is a schematic showing implementation of a channel outlet 34 in depletion wall 20 and a liquid removal device 62 at the terminal end of channel 14. The possibility of a channel with a liquid introduction device and a liquid removal device is depicted in FIG. 7B. FIG. 7B also illustrates the placement of a channel outlet 34 in terminal inlet end 16. FIG. 7C illustrates the placement of channel outlet 34 in an upstream position of a liquid removal device 62. Also illustrated in FIG. 7C is the use of a channel outlet 34 and a liquid removal channel 58 that exit from channel 14 at an angle. An embodiment in which a channel outlet 34 is located in depletion wall 20 and a liquid removal device is located in a terminal outlet end 36 is shown in FIG. 7D. FIG. 7E depicts an implementation using more than one orifices for a liquid removal device 62. A yet further embodiment is depicted by its top view in FIG. 7F with multiple orifices and with orifices located in outlet side wall 46.

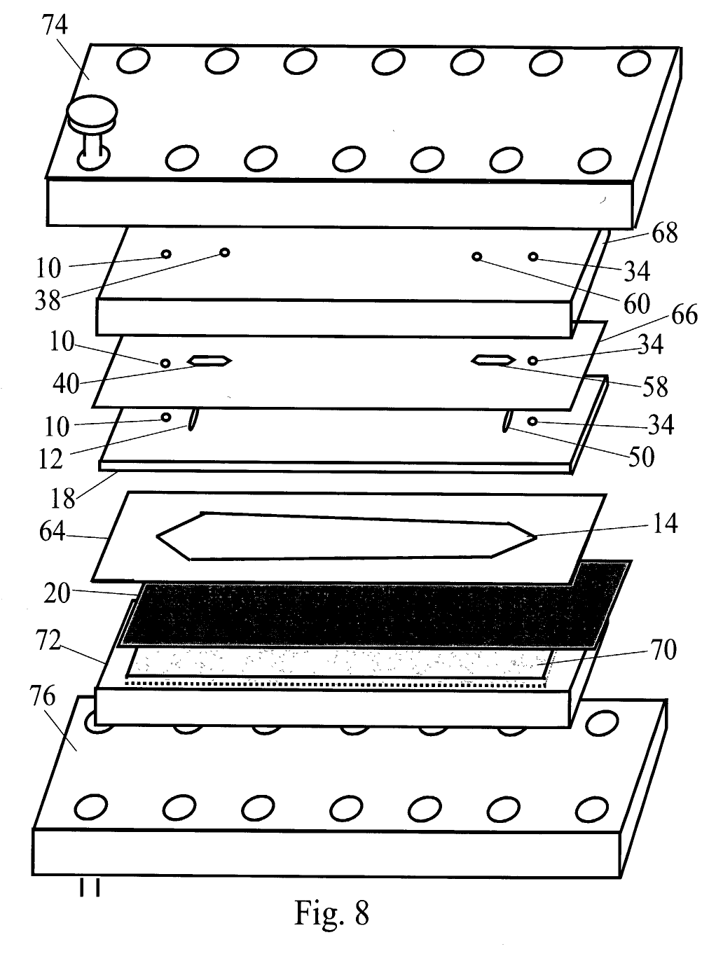

FIG. 8 shows an expanded view of the preferred embodiment of a liquid introduction and removal device as it may be constructed for an asymmetric flow FFF channel.

Many options remain which are not depicted by a figure. For example, an option not shown but possible is the use of a channel 58 in which the walls of the channel are not parallel to each other. Another possibility is a device 62 with a channel 58 in which the cross sectional channel shape is selected from a group of shapes that include circular, triangular, trapezoidal and many other shapes.

6.4 Benefits of the Liquid Removal Device

The use of a simple orifice in combination with a channel outlet provides an effective, low cost stream splitter that is simpler in design than any previous stream splitter used in FFF technology. Our liquid removal device design actually reduces the number of elements needed for previous stream splitters and the elimination of foreign elements such as frits and splitters provides numerous benefits. These benefits include the same benefits as the liquid introduction device: broader compatibility with carrier solvents and samples, no contamination of the separation with particulates or other components that may be shed or leached from the frit or splitter. Production can be stream-lined and production costs can be reduced since only an orifice must be implemented; there are no stringent machining requirements like the requirements imposed by the frit and splitter elements used in previous hydrodynamic relaxation devices, and/or the precise channel dimensions required by the opposed flow focusing devices.

6.5 Benefits of Combination of a Liquid Introduction and Removal Device

An unexpected benefit results from the combination of the liquid introduction and removal device. The modifications used to implement a liquid introduction device are often the same as for the liquid removal device. In fact, the liquid introduction device is the mirror-image of the liquid removal device. Thus similar machining steps can be used which reduces production time and cost. Also a channel with a liquid introduction device only can be re-assembled to form a channel with a liquid removal device. This dual functionality provides the user with multiple options for optimizing the separation performance.

### 7. DESCRIPTION OF THE METHOD

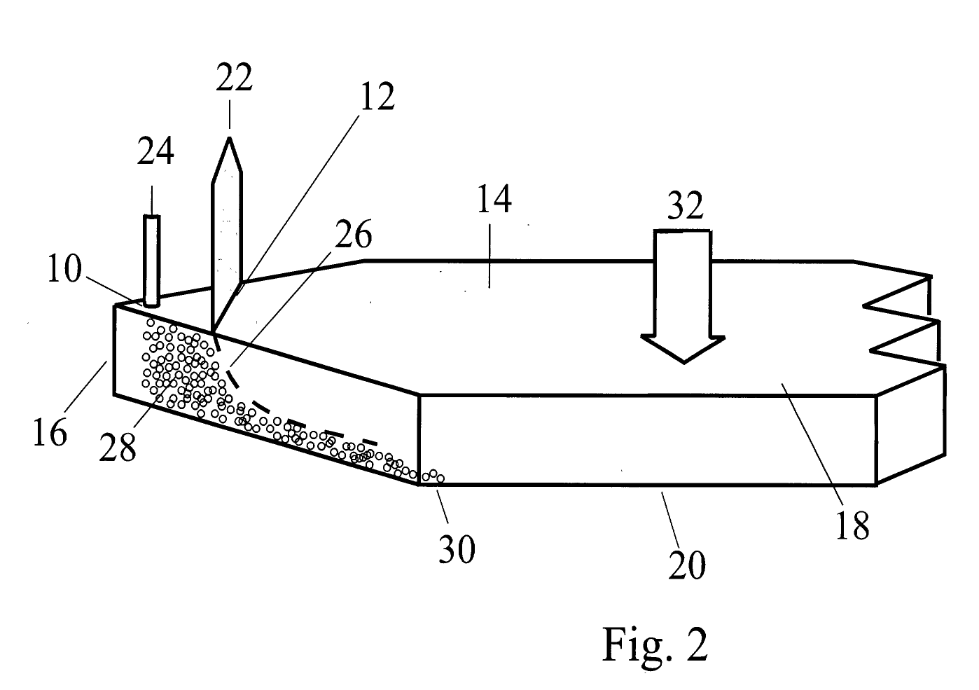

7.1 Description of a Liquid Introduction Method—FIGS. 1 and 2

The exemplary embodiments discussed below are intended to limit neither the scope of the process nor materials that are needed for performing the process.

FIG. 1a displays basic elements of a preferred embodiment of the liquid introduction device with channel inlet 10 and orifice 12 located in channel 14. Channel 14 is the flow cell in which the separation, and in particular the field-flow fractionation, takes place. In its operation mode (cf. FIG. 2), the sample pulse is introduced into a channel inlet flow stream 24 which consists of a stream of carrier that enters the inlet end of the FFF channel through channel inlet 10 near closed terminal end 16. Another flow stream of carrier, an orifice flow stream 22, is introduced into channel 14 through a separate orifice 12. After the desired volume of sample is introduced, sample-free carrier is introduced into channel 14 through channel inlet 10. Typically, all or most of the flow streams contained in channel inlet flow stream 24 and orifice flow stream 22 combine to form the main channel flow which continues down the channel.

Other methods for introducing the sample pulse into a channel can be used which would be obvious to anyone skilled in the art of field-flow fractionation or chromatography. For example, a needle is often used to inject directly into the channel inlet through the use of a septum.

Shown in FIG. 2 is a schematic drawing showing the positioning and equilibration process achieved in a channel using the proposed liquid introduction device. The diagram illustrates one possible configuration of the liquid removal orifice 12 located near the closed terminal inlet end 16 of channel 14. As an orifice flow stream 22 flows into channel 14 through orifice 12, a channel inlet flow stream 24 is displaced in a direction downward from a depletion wall 18 toward an accumulation wall 20. This compression is illustrated by the downward displacement of inlet splitting plane 26. Inlet splitting plane 26 divides orifice flow stream 22 and channel inlet flow stream 24. Sample material 28 that is introduced into channel inlet flow stream 24 will enter at an inlet end 16 of channel 14 and remain below splitting plane 26. Sample material 28 is therefore compressed to the vicinity of accumulation wall 20. Once the sample material 28 is in the vicinity of the accumulation wall 20, the sample components will quickly reach their steady-state positions 30 near an accumulation wall 20, opposite depletion wall 18 because of the driving force of applied field 32.

7.2 Benefits of the Liquid Introduction Method

Use of the liquid introduction method provides all of the benefits of hydrodynamic relaxation without any of the complications found with the use of frits or splitters. Relative to the conventional stop-flow method and the recent opposed flow sample introduction methods, several benefits are evident due to a single feature of hydrodynamic relaxation. That is, liquid flow through the channel is continuous without stopping the flow for sample equilibration and with any flow reversals or pressure transients. One benefit of continuous flow is the stabilization of the detector signals. Pressure transients as well as flow stoppages or reversals result in transient detector signals. These non-ideal detector signals obscure information about sample species.

Another benefit of continuous flow is a simplification of the operation procedures. The software and firmware needed to control the flow changes are no longer necessary. Additionally, the removal of any pressure transients or flow changes from the sample relaxation steps is beneficial to maintaining the relaxed sample in its position next to the channel accumulation. The goal of sample relaxation or equilibration is to position sample in zones located close to the channel accumulation wall. Pressure transients in the channel may disrupt the sample zones. The result is a loss of separation efficiency.

The sample flow through the channel is also continuous. This reduces the opportunity for sample adsorption, precipitation, or aggregation. Ideally, sample recovery from the channel should be 100%. Sample changes such as sample aggregation prevent accurate characterization of the sample.

Simplification of operation is provided by the liquid introduction device over the use of opposed flow focusing techniques. The opposed focusing technique requires a distinct sample introduction step and extra accessory equipment. That is, the focusing procedure involves flows directed in different directions and from different sources. Software and firmware is required to control these flows and their time duration. Often a valve is used to change the flow direction or source. With our liquid introduction device, there is no change in the flow rates or direction between the positioning and the separation processes. There is also no need for extra software or firmware or valves.

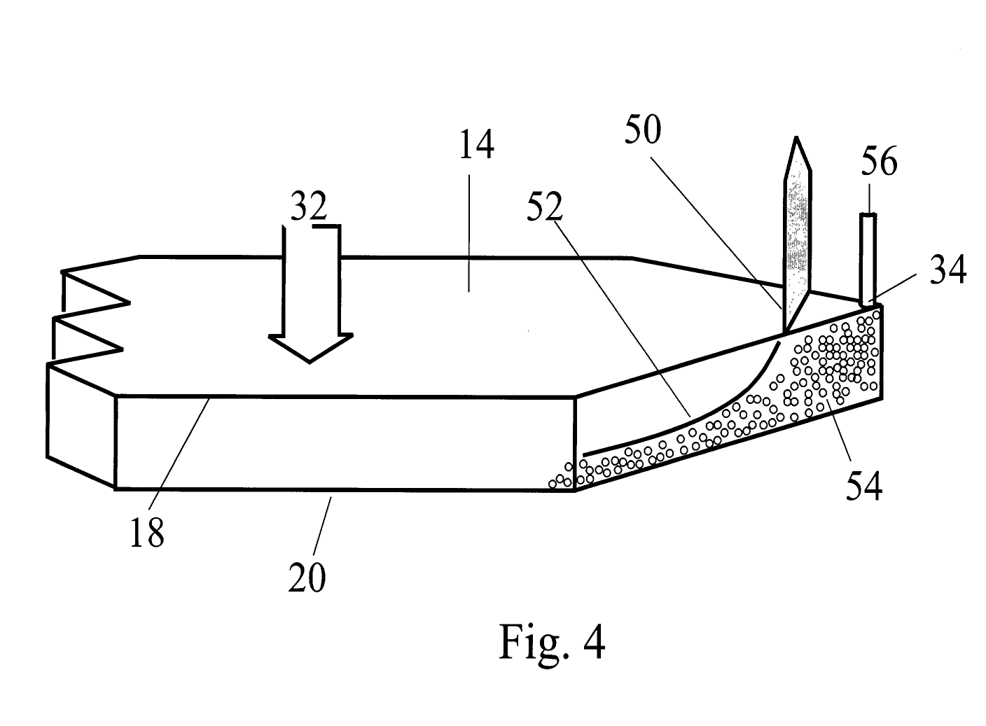

7.3 Description of Liquid Removal Method—FIG. 4

Shown in FIG. 4 is a schematic drawing showing the sample enrichment effect achieved in channel 14 using the liquid removal device. The diagram illustrates one possible configuration of a liquid removal orifice 50 located at or near closed terminal outlet end 36 of channel 14. Carrier liquid close to depletion wall 18 and located above outlet splitting plane 52 will exit channel 14 through liquid removal orifice 50. Carrier liquid next to accumulation wall 20, below outlet splitting plane 52, will exit channel 14 through channel outlet 40. Since a field 32 applied across channel 14 causes sample material to be positioned next to an accumulation wall 20, sample material 54 will be transported out of channel 14 in a channel outlet flow stream 56.

7.4 Benefits of the Liquid Removal Method

The primary beneficial result of the liquid removal method is an increase of sample concentration in the channel outlet flow stream. In turn increased sensitivity to rare populations in the sample is provided. Typically, increased sensitivity can only be achieved by using state-of-the-art detectors at a cost increase of tens of thousands of dollars. Implementation of the liquid removal device is expected add an insignificant amount to the manufacturer cost. Also, the use of smaller amounts of samples is now possible. This is useful as separation techniques perform most optimally with smaller sample loads.

An additional benefit is the decrease of flow rate that is inherent to a liquid removal method. Typically, the sample flow stream exiting the channel will have a flow rate that is 10%-25% in magnitude relative to the flow rate found without implementation of a liquid removal device. Band broadening effects for transfer from sample from the channel to detector are decreased with the reduction of flow rates. The reduced flow rate is well-suited for the use of post channel reaction detection. This is a method in which a reagent is added after the separation. Reaction of the reagent with sample generates a new species which can be detected and the reduced flow rates allow extra time for the reactions to be completed.

The reduced flow rate also improves the response of some chromatographic detectors. For example, on-line dynamic light scattering detectors require a finite amount of time to receive light scattering signals from the sample species. These signals are generated during the passage time of the sample species through the detector cell. At slower flow rates, the passage time is increased. Other detectors perform most optimally with slower liquid flows because the carrier fluid must first be removed before the sample solids can be analyzed. Examples of this type of detector are mass spectroscopic detectors and evaporative mass detectors. Mass spectroscopic detectors are one of the most powerful and frequently used detectors. High resolution and exact definition of the molecular weight of a sample is provided. Thus, increased compatibility of the FFF separation with mass spectroscopic detection is a significant improvement.

7.5 Benefits of Combining the Liquid Introduction and Removal Methods

The combination of the liquid introduction and removal methods has a coincidental benefit. This is manifest, in part, due to the comparability of the two methods. That is, the liquid removal method is a reverse of the liquid introduction method. The sample-free flow stream removed by the liquid removal method at orifice 50 can be used as the sample-free flow stream introduced at orifice 12. More specifically, the pump used to force fluid through orifice 12 can also be used to remove fluid through orifice 50. By using one pump to pump a closed loop of carrier, only one pump is needed to implement the combination of the liquid introduction and removal methods. The volume of carrier fluid needed to implement both methods is also reduced.

An unexpected benefit is found with combining liquid introduction and removal devices. The resulting experimental conditions allow for gentle positioning conditions with continuous flow along the channel accumulation surface plus enhanced sample detection. These two features facilitate the analysis of certain classes of samples. One example is water soluble polymers. Analysis of these species often requires very dilute solutions and relaxation conditions that do not permit the sample to adsorb onto channel walls. Sample detection enhancement and continuous flow relaxation, as provided by a liquid introduction device plus a liquid removal device, are thus a solution for this difficult class of samples.

Another surprising result is generated by use of either a liquid introduction or a liquid removal device. Specifically, the operating process of a liquid introduction method is the opposite of that of a liquid removal method. The benefit is the liquid introduction method can be operated in reverse to generate the beneficial features of the liquid removal method.

### 8. CONSTRUCTION OF PREFERRED EMBODIMENT OF THE FLOW SPLITTING DEVICE

The implementation of the liquid introduction and removal splitting devices should be relatively simple as illustrated in FIG. 8. For channels having a flat, planar structure in which plates are used to form the top and bottom channel walls, an additional layer of a spacer and a plate can be attached to the top channel plate. FIG. 8 illustrates the construction of an asymmetrical flow FFF channel which is modified to include a liquid introduction device. Modification of typical symmetrical flow FFF, thermal FFF, and electrical FFF channels would involve similar construction methods.

A channel cavity 14 is formed by using a channel spacer 64 consisting of a 0.025 cm thick film of Mylar with the channel shape cut out of it. The channel shape is tapered with triangular end pieces. The apex of each triangular end piece is co-linear with the center line of the channel. The initial and final breadth dimensions of channel 14 are 20 mm and 1 mm, respectively. The channel length is 29 cm.

The upper channel wall 18 is made of Lucite in the dimensions of 35 cm×6.5 cm×0.25 cm, in length, breadth and thickness, respectively. Wall 18 is modified with an 8 mm, long, 0.25 mm wide slot cut through the wall which serves as orifice 12. A circular channel inlet 10 with a 0.5 mm diameter is also cut through wall 18. Orifice 12 is positioned approximately 0.50 cm from channel inlet 10 in the upstream direction and is centered on the channel center line.

A 0.25 mm thick film of Mylar is placed on top of the upper channel wall. We term this element a device spacer 66. Two channels are cut out of spacer 66. These cut-outs serve as a liquid introduction channel 40 and a liquid removal channel 58. The shape of each channel is rectangular with triangular shaped end pieces. Dimensions of each channel are 2 cm in length and 0.5 mm in breadth. Channel 40 is positioned so that one channel tip is in the same position as orifice 12 in the underlying top channel wall 18 and the other tip is placed in a downstream position relative to flow through channel 14. Channel 58 is positioned so that one channel tip is in the same position as orifice 50 in the underlying top channel wall 18 and the other tip is placed in a upstream position relative to flow through channel 14.

A block of Lucite, device block 68, in the dimensions of 35 cm×6.5 cm×0.6 cm in length, breadth, and thickness, respectively, is placed upon the spacer 66 so as to seal channels 40 and 58. Holes for channel inlet 10 and outlet 34, as well as liquid introduction and removal ports 38 and 60, respectively, are provided in device block 68. The diameter of each hole is 0.5 mm.

Beneath spacer 64 is a layer of ultra-filtration membrane which functions as the accumulation wall 20. Wall 20 is supported by a ceramic frit 70. A Lucite block 72 is machined with an opening on its top surface so that the upper surface of frit 70 is coplanar with the top surface of block 72.

Channel 14 is sealed by clamping together the sandwich-like assembly of device block 68, device spacer 66, top channel wall 18, channel spacer 64, bottom channel wall 20 and block 72. Clamping blocks 74 and 76 are each made of Lucite in the dimensions of 38 cm×9 cm×5 cm length, breadth, and thickness, respectively. A series of bolt holes are drilled through each block.

8.1. Implementation of the Flow Splitting Devices in Non-planar FFF Channels

A few FFF techniques employ channels which are not flat and planar in structure. However, many still use sandwich-like assembly methods so that the construction methods described above could be used. For example, most Sedimentation FFF channels are curved into a circle. Implementation of liquid introduction and removal devices is possible if device block 68, top channel wall 18 and bottom channel wall 20 are made of flexible materials. Another possibility is to make the elements mentioned above in a curved, concentric form.

Tubular and annular FFF channels are also used. Implementation of liquid introduction and removal devices is possible for these forms through the use of concentric tubes. For example, channels 40 and 58 could be cut out of a thin film of Mylar as instructed for device spacer 66 above. Then spacer 66 could be rolled into a tube and the edges sealed. The extra requirement of tubular and annular geometries is a careful design of tube diameters so as to achieve a seal of channels 14, 40 and 58.

Micro-machining techniques provide other options of construction of a liquid introduction and removal devices. Since channel and cut-out thicknesses are small, etching techniques would be appropriate. Other construction options would be evident to anyone skilled in the art of machining or field-flow fractionation.

### 9. EXAMPLE AND CONCLUSIONS

9.1. Results of Liquid Introduction Method

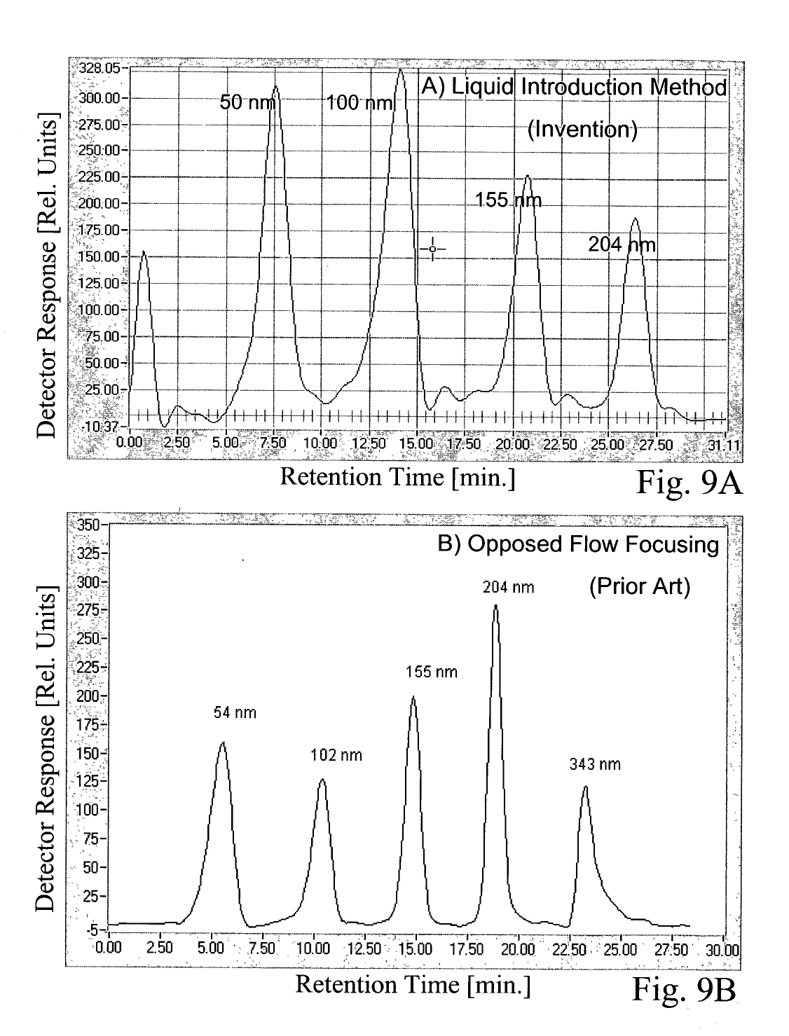

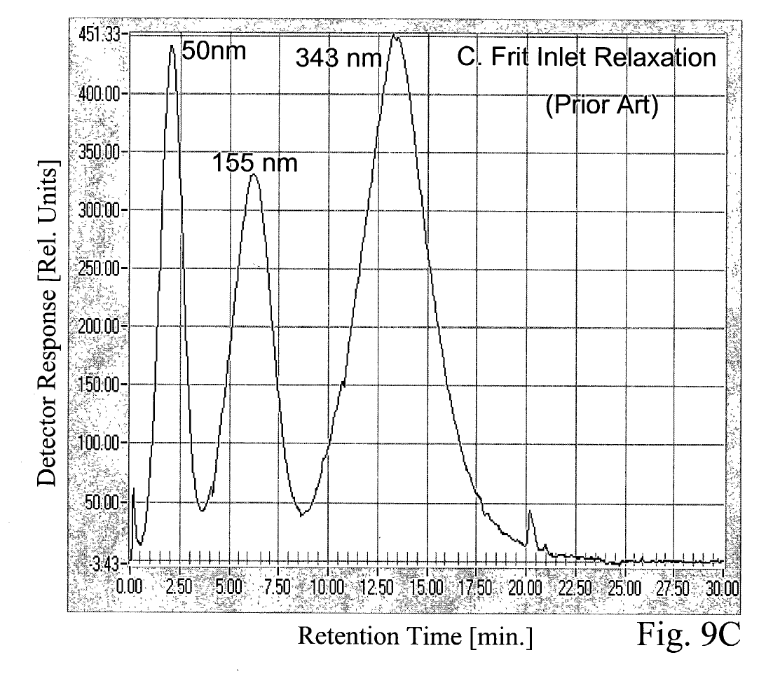

FIG. 9A shows an elution profiles found with the liquid introduction method of the present invention. Also shown are elution profiles of prior art sample relaxation and equilibration methods. Specifically, FIG. 9B represents the most optimal separation of particle standards for opposed flow focusing. FIG. 9C shows the results found with frit inlet sample relaxation. Each of the elution profiles has been scaled for peak heights and time dimensions.

The experimental conditions relevant to each analysis were as follows: FIG. 9A, Liquid introduction method: cross flow rate=1.7 ml/min, channel flow rate=1.6 ml/min, orifice flow stream 3.2 ml/min, channel inlet flow rate 0.1 ml/min, channel thickness=0.0152 cm; FIG. 9B, opposed Flow method: cross flow rate=2.0 ml/min, channel flow rate=1.8 ml/min, channel thickness=0.0152, FIG. 9C, frit inlet method: cross flow rate=0.8 ml/min, channel flow rate=2.1 ml/min, frit inlet flow rate 2.0 ml/min, channel inlet flow rate 0.1 ml/min, channel thickness=0.0142 cm. Particle standards comprised the sample in each case. These particle standards are engineered to have mono-disperse size populations. However, some polydispersity remains for each sample. Typically the nominal coefficient of variation is in the order of 2%, except for standards smaller than 100 nm in diameter. The source of all samples was Duke Scientific (Palo Alto, Calif.). The specific coefficient of variations for the 54 nm, 102 nm, 155 nm, 204 nm, and 343 nm samples were 13.4%, 7.5%, 2%, 1.5%, and 1.5%, respectively.

The peaks generated by the FFF analysis reflect the remaining polydispersity of the sample as well as the efficiency of the separation process. Specifically, the peak width relative to its elution time is a measure of sample efficiency. Experimental conditions such as channel flow rate, field strength and channel dimensions will also affect the sample efficiency. In these cases, experimental conditions were not absolutely identical, but similar enough to allow direct comparison of peak widths. To normalize the peak width measurements relative to peak heights, peak widths may be measured at ½ the peak height. Since elution times are similar, peak width at ½ height values are almost equivalent to separation efficiency. If the results of each particle standard are compared, the peak width comparison is an appropriate measurement of the performance of the liquid introduction method versus previous methods.

Results A surprising result is found for the peak widths of the liquid introduction method versus the opposed flow and frit inlet relaxation methods. That is, the peak widths of the liquid introduction method are much narrower than the peak widths of the frit inlet hydrodynamic relaxation method. Moreover, the peak widths for the opposed flow focusing methods are not significantly smaller than for the liquid introduction method. The peak width at ½ height for the 155 nm standard is 1.4 min, 0.9 min, and 2.6 min for the liquid introduction, the opposed flow focusing and the frit inlet relaxation methods.

The expected degradation of separation efficiency can be seen by comparison of the frit inlet relaxation versus the opposed flow method results. The relative peak widths at ½ height for the 54 nm, 155 nm, and 343 nm particle standards are 1.5 versus 1.33 min., 2.6 versus 1.4 min. and 4.0 versus 0.96 for the frit inlet versus opposed flow methods, respectively. This shows that the separation provided with frit inlet hydrodynamic relaxation is significantly less efficient than that of opposed flow focusing. With samples that are retained longer, a situation for which separation efficiency is emphasized, the peak widths at ½ height are more than 4 times broader. However, the separation efficiency of our liquid introduction device is only slightly reduced versus opposed focusing. This small compromise is insignificant in comparison to the reduced manufacturing costs, accelerated production times, reduced accessory equipment requirements and the possibility to use sensitive pressure dependent detectors (RI) and new detection system (mass spectroscopy) with the system.

9.2. Results of Liquid Removal Method

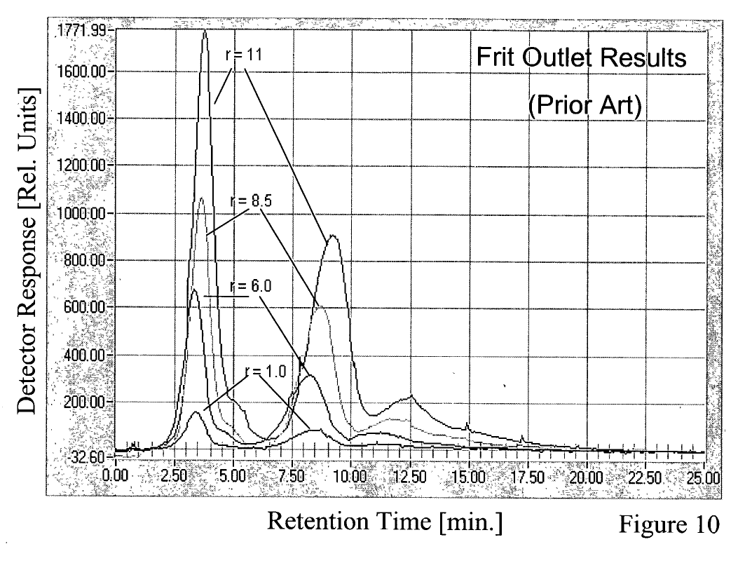

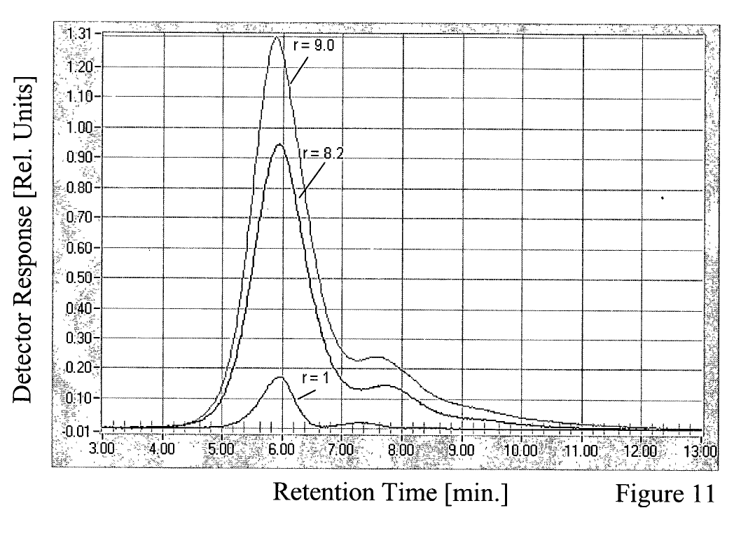

The initial results of a liquid removal device demonstrate that signal enhancement can be achieved with only a simple channel modification and with no compromise in performance. As will be shown in FIGS. 10 and 11, the relative peak heights and peak areas were comparable between the liquid removal device and a frit outlet device.

Experimental conditions: FIG. 10 shows the fractograms resulting from the use of a frit outlet device. The r values denote the ratio of the flow rate through the channel outlet relative to the total of the frit outlet and channel outlet flow rates. An r value of 1 indicates analyses done without a frit outlet. These analyses provide the reference values used to calculate the amount of signal enhancement and sample recovery rates. The channel used was a symmetric Flow FFF channel with length, breadth, and thickness dimensions of 29 cm×2 cm×0.02 cm, respectively. Cross flow rate was 4.0 ml/min; channel flow rate was 2.0 ml/min. Sample used was a mixture of protein standards: bovine serum albumin (BSA) and thyroglobulin. Both of these protein samples consist of monomer with smaller amounts of dimer, and trimer. BSA monomer and dimer species appear at retention times of approximately 3.4 and 4.5 min., respectively. The thyroglobulin monomer, dimer, and trimer species are seen at approximately 8, 11-12, and 15 min, respectively.

FIG. 11 illustrates the type of results possible with a liquid removal device. The channel used was an asymmetric Flow FFF channel with length, initial and final breadth dimensions of 29 cm, 20 mm and 1 mm, respectively; channel thickness was approximately 0.02 cm. Cross flow rate was 3.0 ml/min; channel flow rate was 0.3 ml/min. The orifice flow rate and channel inlet flow rate were 3.2 and 0.1 ml/min, respectively. Sample used was bovine serum albumin (BSA). For all measurements, the BSA monomer species is the predominant peak. The dimer species elute as a shoulder peak following the monomer peak in retention time.

Results: The fractograms of FIG. 10 were generated by use of r ratios in the range of 6-11. The expected increase in peak height and areas is shown. The performance of the frit outlet can be judged by comparing the actual signal enhancement to the signal enhancement predicted by the r ratio. Basically, this measurement reflects the sample recovery rate. Both peak area and peak height are expected to increase. However, the user benefits primarily from an increase in peak height, i.e. detection sensitivity is governed by peak height. Therefore, sample recovery rates were calculated using peak height measurements and the recovery rates found ranged from 63% to nearly 100%.

A liquid introduction device was similarly tested with r values of 1, 8.2, and 9 as shown by FIG. 11. The recovery rates measured using peak heights were essentially equivalent to the results of the frit outlet, ranging from 66% to 99.5%. No compromise in performance is observed by use of the simplified liquid removal device design.

9.3. Conclusions, Ramifications, and Scope

Accordingly, the reader will see that the liquid introduction and removal devices provide multiple benefits with surprisingly simple structures. Implementation of either or both devices involves only minor design changes and none of the design changes require precise machining tolerances. The simplicity is especially beneficial for many reasons. The elimination of foreign elements such as frits or splitters certainly simplifies production and decreases production costs. The absence of frits or splitters is also advantageous to the detection systems. Light scattering detectors are disturbed by particles that are shed by the frits. Elemental detectors are disturbed by elements that may be leached from frits or splitters. For example, it is common to use field-flow fractionation with elemental detector for analysis of environmental particles. The desired result is determination of low levels of metals in each sized classed fraction. Only with extremely clean, uncontaminated separation systems is this possible.

Use of our liquid introduction and removal devices provides for application to a broader range of analytical separations. One reason is that the elimination of foreign elements allows for use of a broader range of carrier fluids. For example, a pH greater than 10 will cause a frit to degrade and shed increasing amounts of particles. A splitter made of stainless steel may be corroded by chlorides which are found in biological buffers and some biological samples are not viable after contact with stainless steel. Organic fluids may interact with sealing agents used to seal in frit in the depletion wall.

The reduced flow rates found with the liquid removal method facilitates the use of sophisticated and powerful detectors such as mass spectroscopic and dynamic light scattering detectors. Moreover, the reduced flow rate enhances detection as well as separation efficiency as band broadening effects of the sample pulse during transit from channel to detector are reduced.

Another reason for increased applicability is the combination of sample detection enhancement plus gentle positioning conditions. These two features are required for many difficult sample types. Samples which cannot be characterized by any other analytical technique can now be analyzed if a liquid introduction plus removal device is used.

1. A field-flow fractionation method for the separation of sample species 28 contained in a carrier fluid, wherein
a stream of the sample species-containing carrier fluid is forced through a flow channel 14 having a depletion wall 18, an accumulation wall 20, side walls, a channel inlet 10, and a channel outlet 34, by introducing the sample species-containing carrier fluid into the flow channel 14 through the channel inlet 10 and withdrawing the sample species-containing carrier fluid through the channel outlet 34,
a field 32 is applied to the carrier fluid in the flow channel 14 to induce a driving force on the sample species 28 acting across the flow channel 14 from the depletion wall 18 towards the accumulation wall 20 and perpendicular to the orientation of the main axis of the flow channel 14,
the sample species 28 are subjected to fractionation as they flow through the flow channel 14 and emerge as sample species fractions at the channel outlet 34, wherein
at least one additional stream of sample species-depleted carrier fluid is introduced into the flow channel 14 through at least one orifice 12 and the relative flow rates of the different streams are adjusted such that the stream of sample species-containing carrier fluid is positioned adjacent to the accumulation wall 20 and the sample species-depleted carrier fluid is positioned between the depletion wall 18 and the sample species-containing carrier fluid,
no mechanical barrier being provided inside the flow channel 14 between the orifice 12 and the channel inlet 10 for separating the stream of sample species-depleted carrier fluid introduced through the orifice 12 and the stream of sample species-containing carrier fluid introduced through the channel inlet 10.

2. The method of claim 1, wherein one additional stream of sample species-depleted carrier fluid is introduced through one orifice 12.

3. The method of claim 1, wherein the orifice 12 has a slot-like shape with its long axis aligned perpendicular to the long axis of the flow channel 14.

4. The method of claim 1, wherein the orifice 12 is located in the depletion wall 18.

5. The method of claim 1, wherein the flow rate of the sample species-depleted carrier fluid is greater than the flow rate of the sample species-containing carrier fluid.

6. The method of claim 1, wherein the sample species-depleted carrier fluid is withdrawn through at least one orifice 50, and
no mechanical barrier is provided inside the flow channel 14 between the orifice 50 and the channel outlet 34 for separating the stream of sample species-depleted carrier fluid withdrawn through the orifice 50 and the stream of sample species-containing carrier fluid withdrawn through the channel outlet 34.

7. A field-flow fractionation method for the separation of sample species 28 contained in a carrier fluid, wherein
a stream of the sample species-containing carrier fluid is forced through a flow channel 14 having a depletion wall 18, an accumulation wall 20, side walls, a channel inlet 10, and a channel outlet 34, by introducing the sample species-containing carrier fluid into the flow channel 14 through the channel inlet 10 and withdrawing the sample species-containing carrier fluid through the channel outlet 34,
a stream of sample species-depleted carrier fluid is forced through the flow channel 14 such that the stream of sample species-containing carrier fluid is positioned adjacent to the accumulation wall 20 and the sample species-depleted carrier fluid is positioned between the depletion wall 18 and the sample species-containing carrier fluid,
a field 32 is applied to the carrier fluid in the flow channel 14 to induce a driving force on the sample species 28 acting across the flow channel 14 from the depletion wall 18 towards the accumulation wall 20 and perpendicular to the orientation of the main axis of the flow channel 14,
the sample species 28 are subjected to fractionation as they flow through the flow channel 14 and emerge as sample species fractions at the channel outlet 34, wherein
the sample species-depleted carrier fluid is withdrawn through at least one orifice 50, and
no mechanical barrier is provided inside the flow channel 14 between the orifice 50 and the channel outlet 34 for separating the stream of sample species-depleted carrier fluid withdrawn through the orifice 50 and the stream of sample species-containing carrier fluid withdrawn through the channel outlet 34.

8. The method of claim 6 or 7, wherein the orifice 50 has a circular shape.

9. The method of any one of claims 1 to 7, wherein the driving force is selected from the group consisting of cross flow of fluid in the flow channel 14, sedimentation, electrical and temperature gradient across the flow channel 14.

10. The method of any one of claims 1 to 7, wherein the sample species-depleted carrier fluid introduced through the channel inlet 10 is free of sample species.

11. An apparatus for field-flow fractionation of sample species 28 contained in a carrier fluid, comprising a flow channel 14 having a depletion wall 18, an accumulation wall 20, side walls, a channel inlet 10 at the inlet end 16 for introducing the sample species-containing carrier fluid, a channel outlet 34 at the outlet end 36 for withdrawing the sample species-containing carrier fluid, and a means for applying a field acting from the depletion wall 18 towards the accumulation wall 20 and perpendicular to the orientation of the main axis of the flow channel 14, wherein
at least one orifice 12 is provided at the inlet end 16 for introducing sample species-depleted carrier fluid into the flow channel 14 such that the sample species-containing carrier fluid is positioned adjacent to the accumulation wall 20 and the sample species-depleted carrier fluid is positioned between the depletion wall 18 and the sample species-containing carrier fluid, and
no mechanical barrier is provided inside the flow channel 14 between the orifice 12 and the channel inlet 10 for separating the stream of sample species-depleted carrier fluid introduced through the orifice 12 and the stream of sample species-containing carrier fluid introduced through the channel inlet 10.

12. The apparatus of claim 11, wherein the channel inlet 10 and the orifice 12 are located in the depletion wall 20, and the orifice 12 is located downstream of the channel inlet 10.

13. The apparatus of claim 11, wherein the orifice 12 is a single slot with its long axis perpendicular to the long axis of the flow channel 14 and with its length no longer than the width of the flow channel 14 at the position of the slot.

14. The apparatus of claim 11, wherein the channel inlet 10 is a pinched inlet.

15. The apparatus of claim 11 which comprises at least one orifice 50 at the outlet end 36 for withdrawing sample species-depleted carrier fluid, wherein no mechanical barrier is provided inside the flow channel 14 between the orifice 50 and the channel outlet 34 for separating the stream of sample species-depleted carrier fluid withdrawn through the orifice 50 and the stream of sample species-containing carrier fluid withdrawn through the channel outlet 34.

16. An apparatus for field-flow fractionation of sample species 28 contained in a carrier fluid, comprising a flow channel 14 having a depletion wall 18, an accumulation wall 20, side walls, a channel inlet 10 at the inlet end 16 for introducing the sample species-containing carrier fluid, a channel outlet 34 at the outlet end 36 for withdrawing the sample species-containing carrier fluid, and a means for applying a field acting from the depletion wall 18 towards the accumulation wall 20 and perpendicular to the orientation of the main axis of the flow channel 14, wherein
at least one orifice 50 is provided at the outlet end 36 for withdrawing sample species-depleted carrier fluid, and
no mechanical barrier is provided inside the flow channel 14 between the orifice 50 and the channel outlet 34 for separating the stream of sample species-depleted carrier fluid withdrawn through the orifice 50 and the stream of sample species-containing carrier fluid withdrawn through the channel outlet 34.

17. The apparatus of claim 16 wherein the orifice 50 and the channel outlet 34 are located in the depletion wall 18, and the orifice 50 is located upstream of the channel outlet 34.

18. The apparatus of claim 16 wherein one orifice 50 is provided at the outlet end 36.

19. The apparatus of claim 16 wherein the orifice 50 has a circular shape.

20. The apparatus of any one of claims 11 to 19, wherein the means for applying a field generates at least one selected from the group consisting of a cross flow of fluid in the flow channel 14, sedimentation, an electrical field, and a temperature gradient across the flow channel 14.
